(19) United States
(12) Patent Application Publication
(10) Pub. No.: US 2024/0317955 A1
(43) Pub. Date: Sep. 26, 2024

(54) FOAMED COMPOSITIONS, FOAM PADDED MATERIALS, AND PACKAGING ARTICLES

(71) Applicant: 3M INNOVATIVE PROPERTIES COMPANY, St. Paul, MN (US)

(72) Inventors: Yaohua Gao, Woodbury, MN (US); Stephen M. Sanocki, Stillwater, MN (US); Sithya S. Khieu, Eden Prairie, MN (US); Ignatius A. Kadoma, Cottage Grove, MN (US); Cory D. Sauer, Star Prairie, WI (US); Tien Yi T.H. Whiting, St. Paul, MN (US); Mitchell A.F. Johnson, Woodbury, MN (US); Jeffrey P. Kalish, Woodbury, MN (US); Daniel L. Schlosser, Roseville, MN (US); Michael Brett Runge, Stillwater, MN (US); Matt R. Branscomb, Lakeville, MN (US)

(21) Appl. No.: 18/274,693

(22) PCT Filed: Jan. 31, 2022
(86) PCT No.: PCT/US2022/014499

§ 371 Date: Jul. 27, 2023

Related U.S. Application Data
(60) Provisional application No. 63/214,648, filed on Jun. 24, 2021.
(60) Provisional application No. 63/160,168, filed on Mar. 12, 2021.
(60) Provisional application No. 63/148,117, filed on Feb. 10, 2021.
(60) Provisional application No. 63/144,360, filed on Feb. 1, 2021.

(51) Int. Cl. C08J 9/00; B65D 81/02; B65D 81/03; C09D 7/40; C09D 129/04; D21H 19/00

(52) U.S. Cl. CPC C08J 9/00; B65D 65/44; B65D 81/03; C09D 7/40; C09D 129/04; D21H 19/00; B65D 2565/385; C08J 2429/04

(57) ABSTRACT

Polymeric foamed compositions, foam padded materials that include such polymeric foamed compositions, and packaging articles (e.g., envelopes) that include such foam padded materials, wherein the foamed composition includes: a polymeric component including a copolymer including divalent hydroxyethylene monomer units and divalent dihydroxybutylene monomer units; wherein the composition is in the form of an at least partially water-soluble foam.

### BACKGROUND

Existing packaging (e.g., shipping envelopes) come in two general forms—with and without a cushioning layer. Cushioning is a key element of protective packaging. The use of closed cell extruded polystyrene foam or bubble wrapping, such as that available under the trade designation BUBBLE WRAP, as a cushioning component in packaging is known. Such materials may not be recyclable or compostable. Thus, most end up as landfill waste. Even if they are recyclable it is established that plastic products are recycled at a much lower rate than paper-based products. More environmentally friendly approaches to making packaging have been attempted based on cellulosic materials and water-based adhesives; however, such packaging materials may not be sufficiently durable to provide suitable properties (e.g., effective thermal insulation, impact protection, and compression resistance).

### SUMMARY

The present disclosure provides polymeric foamed compositions, foam padded materials that include such polymeric foamed compositions, and packaging articles (e.g., envelopes) that include such foam padded materials.

In one embodiment, there is provided a foamed composition that includes: a polymeric component including a copolymer including divalent hydroxyethylene monomer units and divalent dihydroxybutylene monomer units; wherein the composition is in the form of an at least partially water-soluble foam.

In another embodiment, there is provided a recyclable and/or compostable foam padded material that includes: a sheet material having a first and a second major surface, wherein the sheet material includes a recyclable material (e.g., paper); and a foamed composition disposed on the first major surface of the sheet material, the foamed composition is as described herein.

In yet another embodiment, there is provided a packaging article that includes: a first wall having a first interior surface and a first exterior surface opposite the first interior surface; a second wall having a second interior surface and a second exterior surface opposite the second interior surface, the first and second interior surfaces defining an interior of the packaging article and the first and second exterior surfaces defining an exterior of the packaging article; a foamed composition disposed on at least a portion of each of the first and second interior surfaces; and a sealing joint at one or more edges of the first and second walls, the sealing joint including the foamed composition, which attaches the first wall to the second wall; wherein the first and second walls include recyclable material and the foamed composition is as described herein.

Some terms in this disclosure are defined below. Other terms will be familiar to the person of skill in the art and should be afforded the meaning that a person of ordinary skill in the art would have ascribed to them.

The terms “polymer” and “polymeric material” include, but are not limited to, organic homopolymers, copolymers, such as for example, block, graft, random, and copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “copolymer” refers to polymers containing two or more different monomeric units or segments, including terpolymers, tetrapolymers, etc.

The term “compostable” refers to materials, compositions, or articles that meet the standard ASTM D6400 or ASTM D6868. It should be noted that those two standards are applicable to different types of materials, so the material, composition, or article need only meet one of them, usually whichever is most applicable, to be “compostable” as defined herein. In certain embodiments, the term “compostable” preferably refers to materials, compositions, or articles that meet the standard ASTM D6400. Particularly, compostable materials, compositions, or articles will also meet the ASTM D5338 standard. Particularly, compostable materials, compositions, or articles will also meet one or more of the EN 13432, AS 4736, AS 5810, or ISO 17088 standards. More particularly, compostable materials, compositions, or articles will also meet the ISO 14855 standard.

It should be noted that the term “compostable” as used herein is not interchangeable with the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade nor does it specify that the compounds into which it degrades pass any standard for toxicity or lack of harm to the environment. For example, materials that meet the ASTM D6400 standard must pass the test specified in ISO 17088, which addresses “the presence of high levels of regulated metals and other harmful components,” whereas a material that is “biodegradable” may have any level of harmful components.

The term “recyclable” refers to materials, compositions, or articles that meet at least one of the Voluntary Standard for Repulping and Recycling Corrugated Fiberboard as promulgated by the Fibre Box Association (FBA) part 1 (repulpability), Voluntary Standard for Repulping and Recycling Corrugated Fiberboard as promulgated by the Fibre Box Association (FBA) part 2 (recyclability), and ISO 18601 standards. Particular recyclable items meet the Voluntary Standard for Repulping and Recycling Corrugated Fiberboard part 1 (repulpability). Particular recyclable items meet the Voluntary Standard for Repulping and Recycling Corrugated Fiberboard part 2 (recyclability). More particular recyclable items meet the Voluntary Standard for Repulping and Recycling Corrugated Fiberboard part 1 (repulpability) and part 2 (recyclability). Still more particularly, recyclable items meet the Voluntary Standard for Repulping and Recycling Corrugated Fiberboard part 1 (repulpability) and part 2 (recyclability) standards, as well as the ISO 18601 standard. Even more particularly, recyclable items additionally meet the ISO 18604:2013 standard. All references to the Voluntary Standard for Repulping and Recycling Corrugated Fiberboard standard, whether to part 1, part 2, or both, refer to the 2013 version of the standard. It should be noted that a recyclable material may include materials, such as adhesives, that do not meet one or more of the above standards. This is because materials, particularly adhesives, are commonly removed from paper products during the recycling process. Such materials, especially adhesives, that are not themselves recyclable but are readily removed from a product during the recycling process are referred to herein as “recycle-compatible.” A “recyclable” article thus may contain components that are recyclable as well as components that are recycle-compatible.

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

Terms indicating a high frequency, such as (but not limited to) “common,” “typical,” and “usual,” as well as “commonly,” “typically,” and “usually” are used herein to refer to features that are often employed in the disclosure and, unless specifically used with reference to the prior art, are not intended to mean that the features are present in the prior art, much less that those features are common, usual, or typical in the prior art.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIGS. 1A-1G are plan views of exemplary foam padded materials;

FIG. 2 is a schematic of an exemplary packaging article:

FIG. 3 is a schematic of another exemplary packaging article:

FIG. 4 is a schematic of yet another exemplary packaging article:

FIGS. 5 and 6 are schematics of still another exemplary packaging article with a flap in the open (5) and closed (6) configurations:

FIG. 7A is a schematic of another exemplary packaging article with an adhesive portion:

FIG. 7B is a schematic of yet another exemplary packaging article with two adhesive portions on a flap:

FIGS. 8A and 8B are schematics of an exemplary packaging article:

FIGS. 9A and 9B are plan views of a template used in a screen printing process and a foam padded material, respectively, formed from such process:

FIGS. 10A and 10B are schematics of an unwind station and a die coating station, respectively, used in a random element printing process:

FIGS. 11A-11C are schematics of exemplary packaging articles:

FIG. 12 is a 3D printed rotogravure printing roll with a pattern on the surface:

FIGS. 13A and 13B are schematics of another packaging article:

FIG. 14 is a schematic of a 3D printed rotogravure roll:

FIG. 15 is a drawing showing a rotogravure cell dimension for dl which the diameter of an inscribed circle tangent to the sides of a hexagon drawn by connecting the centers of the individual cells in the rotogravure array:

FIG. 16 is a plan view of an embodiment of the invention with foamed composition forming a plurality of foam bubbles in a patterned array attached to a substrate:

FIG. 17 is a cross-section of the embodiment of FIG. 16 showing each foam bubble comprises an exterior shell of a foamed composition and a hollow interior filled with air; and

FIG. 18 is a schematic of a mailer made from the embodiment of FIG. 16 with heat sealed seams where the foam bubbles were compressed and heat sealed together to form a pouch with an interior having a cushioning array of foam bubbles.

### DETAILED DESCRIPTION

The present disclosure provides polymeric foamed compositions. The foamed composition includes: a polymeric component including a copolymer that includes divalent hydroxyethylene monomer units and divalent dihydroxybutylene monomer units, wherein the composition is in the form of an at least partially water-soluble foam.

Such polymeric foamed compositions can be used in recyclable and/or compostable foam padded materials and packaging articles (e.g., envelopes). The foam padded material includes: a sheet material 10 having a first major surface 12 and a second major surface 14 opposing the first major surface, wherein the sheet material includes recyclable material; and a foamed composition 16, as described herein, disposed on the first major surface 12 of the sheet material.

Briefly, a packaging article includes a first wall having a first interior surface and a first exterior surface opposite the first interior surface as well as a second wall having a second interior surface and a second exterior surface opposite the second interior surface. The first and second interior surfaces define an interior of the packaging article and the first and second exterior surfaces define an exterior of the packaging article. The packaging article has one or more edges where the first wall is attached to the second wall at a sealing joint. Optionally, the article may have at least one opening where the first wall is not attached to the second wall; this is not required in all cases because it is possible form the packaging article around an object to be placed in the interior of the packaging article thereby eliminating the need for an article with an opening. A foamed composition, as described herein, is disposed on at least a portion of each of the first and second interior surfaces. Preferably, the foamed composition also forms the sealing joint, thereby attaching the first wall to the second wall of the packaging article.

In certain embodiments, the polymeric foamed compositions, foam padded materials, or packaging articles are recyclable. In certain embodiments, the polymeric foamed compositions, foam padded materials, or packaging articles are compostable. In certain embodiments, the polymeric foamed compositions, foam padded materials, or packaging articles are both recyclable and compostable.

### Foamed Composition

The foamed composition is an organic polymeric foam, i.e., a composite of a polymer matrix (i.e., polymeric component) and a gas dispersed therein, typically in bubbles or cells. During foam volumetric expansion, a gas phase is initially dispersed into a continuous polymeric phase. A polymeric foam can be prepared mechanically (e.g., by air dispersion), physically (e.g., by gas injection, bead foaming, expandable microspheres), or chemically (e.g., by using a foaming agent that generates effective gases through thermal decomposition).

Such foamed compositions typically include closed cell foams although open cell foams are also possible. In certain embodiments, the foams include closed cells, optionally with open cells and/or ruptured cells.

The foamed compositions of the present disclosure typically have a density of at least 0.01 gram per cubic centimeter (g/cc), and up to 0.5 g/cc, measured according to ASTM D3575-14 (“Standard Test Methods for Flexible Cellular Materials Made from Olefin Polymers” using a pycnometer (DELTARANGE Model AG204 from Mettler-Toledo, LLC, Columbus, OH) and density calculated using Archimedes” Principal).

The foamed compositions of the present disclosure are at least partially water soluble, and preferably 100% water soluble. In the context of the foam (i.e., foamed composition), an at least partially water-soluble foam means at least 50% of the foam dissolves in 130° F. (54° C.) water according to the Water Solubility Test described in the Examples Section. In certain embodiments, at least 60%, at least 70%, at least 80%, at least 85%, at least 90%, at least 95% of the foam (i.e., foamed composition) dissolves in 130° F. (54° C.) water according to the Water Solubility Test described in the Examples Section. Such foamed compositions include water-soluble components such as one or more polymers, and one or more optional water-soluble additives, as described in greater detail below.

The foamed compositions (i.e., foams) of the present disclosure are preferably heat-scalable By this it is meant that a foamed composition is sufficiently thermoplastic that it liquefies and flows upon being exposed to thermal energy, mechanical energy, or a combination thereof (e.g., heat sealing, sonic welding) and re-solidifies upon cooling, thereby providing a seal between two substrate materials having the foamed composition disposed therebetween. The scalability of the foamed compositions can be quantified using the Seam Strength Test described in the Examples Section. In certain embodiments, the foamed compositions of the present disclosure have a seam strength of at least 1.0 lbf/in.

The foamed compositions (i.e., foams) of the present disclosure are preferably durable, Durability refers to a combination of many tactors, including, for example, the strength and internal integrity of the foam, adhesion of the foam to a substrate, as demonstrated by foam shedding or adhesion to paper, the ability of foam to absorb impact, and the ability of the foam, to resist compression. The durability of the foamed compositions can be quantified by the Abrasion Resistance Test, and the Compression Strength and Energy Absorption and Loss Test, which are described in the Examples Section.

In certain embodiments, the foamed compositions of the present disclosure have a shedding mass loss of foam from taber abrasion of no greater than 30% no greater than 20%, or no greater than 10%, after 30 cycles of abrasion with 1100 grams of total weight exerted from the top according to the Abrasion Resistance Test.

In certain embodiments, the foamed compositions of the present disclosure have an absorption energy loss of at least 100 KJ according to the Compression Strength and Energy Absorption and Loss Test. In certain embodiments, the foamed compositions of the present disclosure have an absorption energy loss of up to 275 KJ according to the Compression Strength and Energy Absorption and Loss Test.

In certain embodiments, the foamed compositions of the present disclosure have a compression stress at 50% compression strain of at least 8 kPa according to the Compression Strength and Energy Absorption and Loss Test. In certain embodiments, the foamed compositions of the present disclosure have a compression stress at 50% compression strain of up to 25 kPa according to the Compression Strength and Energy Absorption and Loss Test.

In certain embodiments, the polymeric component (i.e., polymer matrix) of the foamed composition, which may include one or more polymers, is present in an amount of at least 60 wt-%, at least 65 wt-%, at least 70 wt-%, at least 75 wt-%, at least 80 wt-%, at least 85 wt-% or at least 90 wt-% based on the total weight of the foamed composition (i.e, the final (dried) foam, which may include residual water). In certain embodiments, the polymeric component of the foamed composition, which may include one or more polymers, is present in an amount of up to 99.5 wt %, based on the total weight of the (final) foamed composition. The remainder of the foamed composition includes a gas (e.g., air) dispersed therein, and may also include one or more foaming agents (e.g., expandable microspheres), residue of such foaming agents after the composition has been foamed (e.g., expanded microspheres), fillers, and other optional additives, as described in greater detail below. In certain preferred embodiments, the remainder of the foamed composition includes a gas and expanded microspheres (i.e., the foaming agent residue resulting after the composition is foamed and the expandable microspheres have expanded), as discussed below.

The polymeric component of the foamed composition is formed using a water-based polymer or mixture of polymers that are typically selected to be foamable, at least partially water soluble, and preferably provide one or more of the following properties to a foam padded material or packaging article; impact protection, cushioning, thermal insulation; compression resistance, water resistance; recyclability, and/or compostability.

For foamability, such polymers are generally highly plasticized by water. This allows efficient foaming, particularly when the foaming is provided by expansion of expandable microspheres upon heating. The water-based polymers are typically prepared by emulsion polymerization using a single grade or a mixture of emulsion polymers, which may be of synthetic or natural origin.

Preferably, the one or more water-based polymers are water-soluble polymers. In the context of the polymer, water soluble means at least 90 wt-% of the polymer dissolves in 30° F. (54° C.) water, in a procedure analogous to the Water Solubility Test described in the Examples Section. In certain embodiments, at least 95 wt-%, or at least 99 wt-%, of a water-soluble polymer dissolves in 130° F. (54° C.) water, in a procedure analogous to the Water Solubility Test described in the Examples Section.

In certain embodiments, the polymeric component includes a copolymer, preferably, a water-soluble copolymer, that includes divalent hydroxyethylene monomer units (i.e., —CH₂—CH(OH)—) and divalent dihydroxybutylene monomer units (referred to herein as a “hydroxyethylene-butylene copolymer”). In certain embodiments, the polymeric component may include one or more of such hydroxy-ethylene-butylene copolymers (e.g., varying by monomer composition, molecular weight, melt flow index). In preferred embodiments, the divalent dihydroxybutylene monomer units comprise 3,4-dihydroxybutan-1,2-diyl monomer units (i.e., monomer units of the structure

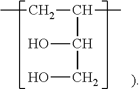

Optionally, but typically, the copolymer further includes acetoxyethylene divalent monomeric units (i.e., monomer units of the structure

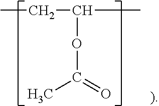

The copolymer may be obtained by copolymerization of vinyl acetate and 3,4-dihydroxy-1-butene followed by partial or complete saponification of the acetoxy groups to form hydroxyl groups. Alternatively, in place of 3,4-dihydroxy-1-butene, a carbonate such as:

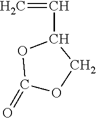

can also be used. After copolymerization, this carbonate may be hydrolyzed simultaneously with saponification of the acetate groups. In another embodiment, in place of 3,4-dihydroxy-1-butene, an acetal or ketal having the formula

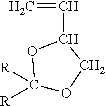

can be used, where each R is independently hydrogen or alkyl (e.g., methyl or ethyl). After copolymerization, this carbonate may be hydrolyzed simultaneously with saponification of the acetate groups, or separately. The copolymer can be made according to known methods or obtained from a commercial supplier, for example.

Commercially available water-soluble copolymers may include those available under the trade designation Nichigo G-Polymer (Nippon Gohsei Synthetic Chemical Industry. Osaka. Japan), a highly amorphous polyvinyl alcohol, that is believed to have divalent monomer units of hydroxyethylene, 3,4-dihydroxybutan-1,2-diyl, and optionally acetoxyethylene. Nippon Gohsei also refers to Nichigo G-Polymer by the chemical name butenediol vinyl alcohol (BVOH). Exemplary materials include Nichigo G-Polymer grades AZF8035W. OKS-1024, OKS-8041, OKS-8089, OKS-8118, OKS-6026, OKS-1011, OKS-8049, OKS-8074P, OKS-1028, OKS-1027. OKS-1109. OKS-1081, and OKS-1083. An exemplary G-Polymer is available under the tradename OKS-8074P from Soarus LLC, Arlington Heights, IL, USA. These hydroxy-ethylene-butylene copolymers are believed to have a saponification degree of 80 to 97.9 mole percent, and further contain an alkylene oxide adduct of a polyvalent alcohol containing 5 to 9 moles of an alkylene oxide per mole of the polyvalent alcohol.

A hydroxy-ethylene-butylene copolymer is selected to provide foamability, at least partial water-solubility, and preferably durability and/or heat-sealability, to the foamed composition. Physical properties of the hydroxy-ethylene-butylene copolymer that may contribute to such performance properties include melt flow index, molecular w eight, melt temperature, and degradation temperature.

In certain embodiments, one or more of the hydroxy-ethylene-butylene copolymers in the polymeric component has a melt flow index of at least 0.1 gram (g) per 10 minutes (min), or at least 0.5 g per 10 min (measured at 210° C. with a load of 2.16 kg). In certain embodiments, one or more of the hydroxy-ethylene-butylene copolymers in the polymeric component has a melt flow index of up to 60 g per 10 min, up to 50 g per 10 min, up to 40 g per 10 min, up to 30 g per 10 min, up to 20 g per 10 min, or up to 10 g per 10 min (measured at 210° C. with a load of 2.16 kg).

In certain embodiments, one or more of the hydroxy-ethylene-butylene copolymers in the polymeric component has a melt temperature of at least 90° C. at least 140° C., or at least 155° C. (measured by differential scanning calorimetry (DSC)). In certain embodiments, one or more of the hydroxy-ethylene-butylene copolymers in the polymeric component has a melt temperature of up to 220° C., up to 200° C., or up to 195° C. (measured by DSC).

These hydroxy-ethylene-butylene copolymers may be used alone as the polymeric component of the foam or may be used in combination with other (secondary) organic polymers. These secondary polymers may or may not be water soluble.

In certain embodiments, one or more hydroxy-ethylene-butylene copolymers are present in the polymeric component in an amount of at least 1 wt-%, at least 10 wt-%, at least 15 wt-%, at least 25 wt-%, at least 50 wt-%, at least 60 wt-%, or at least 70 wt-% based on the total weight of the polymeric component of the (final) foamed composition. In certain embodiments, one or more hydroxy-ethylene-butylene copolymers are present in the polymeric component in an amount of up to 100 wt-%, up to 90 wt-%, or up to 80 wt-%, based on the total weight of the polymeric component of the (final) foamed composition. These values also characterize the polymeric component, prior to foaming, if the water of the foamable composition is not included.

In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the hydroxy-ethylene-butylene copolymer, based on the total weight of the (final) foamed composition. In certain embodiments, a foamed composition is formed from a foamable water-containing composition that includes up to 99.5 wt-%, up to 95 wt-%, up to 90 wt-%, up to 80 wt-%, up to 70 wt-%, or up to 60 wt-%, of the hydroxyethylene-butylene copolymer, based on the total weight of the (final) foamed composition.

If used, one or more secondary polymers is present in the polymeric component in an amount of up to 99%, up to 90%, up to 80%, up to 75 wt-%, up to 60 wt-%, up to 50 wt-%, up to 40 wt-%, or up to 30 wt-%, based on the total weight of the polymeric component of the (final) foamed composition. If used, one or more secondary polymers is present in the polymeric component in an amount of at least 10 wt-%, at least 20 wt-%, at least 30 wt-%, at least 40 wt-%, or at least 50 wt-%, based on the total weight of the polymeric component of the (final) foamed composition.

In certain embodiments, the polymeric component includes a secondary polymer selected from the group of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (methyl)acrylic, styrene (meth)acrylic, (meth)acrylic, styrene butyl rubber, natural rubber, styrenic block copolymer, polyurethane, and mixtures thereof. One such commercially available polymer is that available wider the tradename Dur-O-Set (Celanese, Florence, KY USA), a polyvinyl, alcohol stabilized vinyl acetate ethylene (VAE) emulsion. In certain embodiments, the secondary polymer can be neutral or contain charged monomers (anionic, cationic, zwitterionic).

Suitable polymers for making the foamed composition are typically obtained from a supplier in pellet or powder form and dissolved or dispersed in water. Or they may be obtained as a water-based dispersion or emulsion Typically, such dispersions or emulsions have a solids content of 10 wt-% to 70 wt-%. Thus, a foamed composition of the present disclosure (i.e., a final foam) is prepared from a water-containing formulation, referred to herein as a “foamable” composition.

In certain embodiments, a foamed composition is formed from a foamable water-containing composition that includes a solids content (i.e., anything other than water) of at least 20 wt-%, at least 30 wt-%, at least 40 wt-%, or at least 50 wt-%, based on the total weight of the foamable composition prior to foaming. In certain embodiments, the foamed composition is formed from a water-containing composition that includes a solids content of up to 70 wt-%, or up to 60 wt-%, based on the total weight of the foamable composition prior to foaming. The solids include the polymeric component, and any solid foaming agents (or solid residues remaining after foaming), fillers, and other optional solid additives.

In certain embodiments, the foamed composition is formed from a foamable water-containing composition that includes a foaming agent, such as expandable microspheres. Although these are not required as other mechanisms of foaming are possible, as discussed below, if they are used, the expandable microspheres are present in an amount of up to 20 wt-%, or up to 15 wt-%, based on the total weight of the composition prior to foaming. In certain embodiments, if they are used, the expandable microspheres are present in an amount of at least 0.5 wt-%, based on the total weight of the composition prior to foaming.

In certain embodiments, the expandable microspheres are heat expandable polymeric microspheres. That is, the expandable microspheres are capable of expanding in size in the presence of heat and/or radiation energy (including, for example, microwave, infrared, radiofrequency, and/or ultrasonic energy).

The expandable microspheres have a particular temperature at which they begin to expand (initial expansion temperature or T₀) and a second temperature at which they have reached maximum expansion (maximum expansion temperature or Tₘ). Different grades of microspheres have different onset expansion temperature and maximum expansion temperature. For example, one particularly useful microsphere has a T₀ of 80° C. to 150° C. The temperature at which the microspheres have reached maximum expansion (T) is desirably from 100° C. to 200° C. Although the choice of the particular microspheres and their respective T₀ and Tₘ is not critical, the processing temperatures may be modified depending upon these temperatures. Before the composition is fully dried, these microspheres are able to move within the composition and are able to expand. Once the composition is fully dry, however, the microspheres are substantially locked in place. The expanded composition typically has a greater than 2000%, preferably greater than 2500%, total volume expansion from a wet or partially dry composition.

In certain embodiments, the expandable microspheres have a polymeric shell and a hydrocarbon core (e.g., a polyacrylonitrile shell.

Suitable microspheres include, for example, heat expandable polymeric microspheres, including those having a hydrocarbon core and a polyacrylonitrile shell (such as those sold under the trade name DUALITE) and other similar microspheres (such as those sold under the trade name EXPANCEL, such as EXPANCEL 043 DU 80).

The expandable microspheres may have any unexpanded size, including from 5 microns to 30 microns in diameter. In the presence of heat, the expandable microspheres of the present invention may be capable of increasing in diameter by 3 times to 10 times. Upon expansion of the microspheres in the composition, the composition becomes a foamed material. Alternatively, the expandable microspheres can be pre-expanded before combining with the polymer component and fully expanded without a need to undergo further expansion.

While expandable microspheres are preferred, other mechanisms of foaming can be used if desired. For example, a polymeric foam can be prepared mechanically (e.g., by air dispersion), physically (e.g., by gas injection, bead foaming, expandable microspheres), or chemically (e.g., by using a foaming agent that generates effective gases through thermal decomposition). Foaming agents other than expandable microspheres can be used including, for example, physical blowing agents or chemical blowing agents. If they are used, one or more foaming agents are present in an amount of up to 20 wt-%, or up to 15 wt-%, based on the total weight of the composition prior to foaming. In certain embodiments, if they are used, one or more foaming agents are present in an amount of at least 0.5 wt-%, based on the total weight of the composition prior to foaming.

A physical blowing agent useful in forming the foamed composition of the present disclosure can include a wide variety of naturally occurring atmospheric materials that are vapors at the temperature and pressure at which the foam is formed. A physical blowing agent may be introduced into the polymeric component as a gas, liquid, or supercritical fluid, preferably as a liquid. A physical blowing agent is usually in a supercritical state at the conditions existing during the foaming process. If a physical blowing agent is used, it is preferable that it is soluble in the polymeric component being used. The physical blowing agents used will depend on the properties sought in the resulting foam articles. Other factors considered in choosing a blowing agent are its toxicity, vapor pressure profile, and ease of handling. Flammable blowing agents such as pentane, butane and other organic materials, such as hydrofluorocarbons (HFC) and hydrochlorofluorocarbons (HCFC) may be used, but non-flammable, non-toxic, non-ozone depleting blowing agents are preferred because they are easier to use, e.g., fewer environmental and safety concerns. Suitable physical blowing agents include, for example, carbon dioxide, nitrogen, SF₆, nitrous oxide, perfluorinated fluids, such as C₂F₆, argon, helium, noble gases, such as xenon, air (nitrogen and oxygen blend), and blends of these materials, hydrofluorocarbons (HFC) and hydrochlorofluorocarbons (HCFC).

Suitable chemical blowing agents include, for example, sodium bicarbonate and citric acid blend, dinitrosopentamethylenetetramine, p-toluenesulfonyl hydrazide, 4-4′-oxybis (benzenesulfonyl hydrazide, azodicarbonamide (1,1′-azobisformamide), meta-modified azodicarbonides, p-toluenesulfonyl semicarbazide, 5phenyltetrazole, 5-phenyltetrazole analogues, diisopropylhydrazodicarboxylate, 5-phenyl-4-oxadiazin-2-one, and sodium borohydride. Another exemplary chemical blowing agent includes that available from Avient, Avon Lake, OH, under the trade name HYDROCEROL 40 CB.

The foamed composition, and the water-containing foamable composition from which it is formed, may also include one or more additional optional additives. Examples of suitable optional additives include tackifiers (e.g., rosin esters, terpenes, phenols, and aliphatic, aromatic, or mixtures of aliphatic and aromatic synthetic hydrocarbon resins), plasticizers (other than physical blowing agents), nucleating agents (e.g., talc, silicon, or TiO₂), colorants (e.g., pigments, dyes), reinforcing agents, solid fillers (e.g., pearl starch, physically modified starch, chemically modified starch, glass microspheres, clay, cork, saw dust, sand, inorganic particles (e.g., ceramic or metal), organic particles (e.g., carbon black particles, wood pulp, nanocrystal cellulose, crosslinked polymeric particles that are insoluble in water such as polystyrene-divinylbenzene)), rheology modifiers, toughening agents, thickening agents (e.g., water-soluble cellulose ethers, fumed silica, thermoplastic starch, synthetic polymers or oligomers that can be linear, branched, hyperbranched, dendritic, or star in structure), flame retardants, preservatives (e.g., biocide, 1,2-benzisothiazolin-3-one, 5-chloro-2-methyl-4-isothiazolin-3-one and 2-methyl-4-isothiazolin-3-one), antioxidants, defoamers, crosslinkers (to increase the structural integrity of the composition after the microspheres are expanded), waxes (e.g., paraffin wax, beeswax, synthetic polyethylene wax), stabilizers (e.g., UV stabilizers), humectants, accelerators, anti-static agents, slip agents, and combinations thereof.

Although tackifiers can be used, they are typically not used in the foamable/foamed compositions of the present disclosure. Although the foamed compositions of the present disclosure can function as thermoplastic structural adhesives, particularly in forming a sealing joint (i.e., seam), they are preferably not pressure sensitive adhesives.

The optional additives may be used in various combinations and in amounts sufficient to obtain the desired properties for the foam being produced. Typically, one or more such additives are present in an amount of at least 0.05 wt-%, based on the total weight of the foamable water-containing composition (prior to foaming). In certain embodiments, one or more optional additives in an amount of up to 15 wt-%, up to 10 wt-%, or up to 5 wt-%, based on the total weight of the foamable water-containing composition (prior to foaming).

The foamable compositions of the present disclosure desirably have a viscosity which permits high speed printing/coating/spraying/spreading/overlaying or similar process to deposit onto a substrate. Useful ranges of viscosities include 300 to 100,000 cPs at 25° C., and desirably 1000 cPs to 70,000 cPs at 25° C., as measured with a rheometer at a shear rate of 0.1 to 1 l/sec (Hz) according to the Brookfield Viscosity Test in the Examples Section.

Various methods of printing, coating, spraying, spreading, overlaying, or otherwise applying a foamable water-containing composition to a substrate may be used to form a foamed composition of the present disclosure. In particular, screen printing, rotogravure printing, and random element printing methods may be used, as described in the Examples Section.

Following application of a foamable water-containing composition as described herein to a substrate, the coated substrate is subjected to conditions that cause foaming of the foamable composition. This preferably includes exposing the coated substrate to an elevated temperature for a period of time effective to form a foam and adhere the foam to the substrate. In certain embodiments, the temperature is at or above the melting temperature of the polymeric component of the foamable composition. For a polymeric component that includes one or more hydroxyethylene-butylene copolymers, a temperature of at least 170° C. for at least 1 minute, is preferred. Too low a temperature and/or too short a period of time for this step may result in a foam being formed, but the foam may not adhere sufficiently to the substrate or form a microstructure sufficient to provide cushioning or other desired function.

### Coated Substrates

The present disclosure provides a coated substrate that includes a sheet material with a surface having disposed thereon a foamed composition as described herein. Such coated substrates can be used in packaging materials to provide padding and impart one or more of the following properties to a foam padded material or packaging article; impact protection; cushioning; thermal insulation; compression resistance; water resistance; recyclability; and/or compostability.

Preferably, the coated substrate is a recyclable and/or compostable foam padded material suitable for use in making packaging articles. More specifically, the foam padded material includes a sheet material 10 having a first and a second major surface (12, 14), wherein the sheet material comprises recyclable material, and a foamed composition 16 disposed on the first major surface 12 of the sheet material, the foamed composition comprising: a polymeric component comprising a water-soluble copolymer that includes divalent hydroxyethylene monomer units and divalent dihydroxybutylene monomer units; wherein the foamed composition is in the form of an at least partially water-soluble foam.

The foamed composition may form a continuous or discontinuous coating on the surface of the substrate (e.g., sheet material) or a combination of the two. In certain embodiments, the foamed composition is disposed in a discontinuous pattern comprising an array of discrete elements. Such discrete elements can be in the form of a wide variety of geometric shapes, such as squares, rectangles, triangles, spirals, lines, circles, and the like.

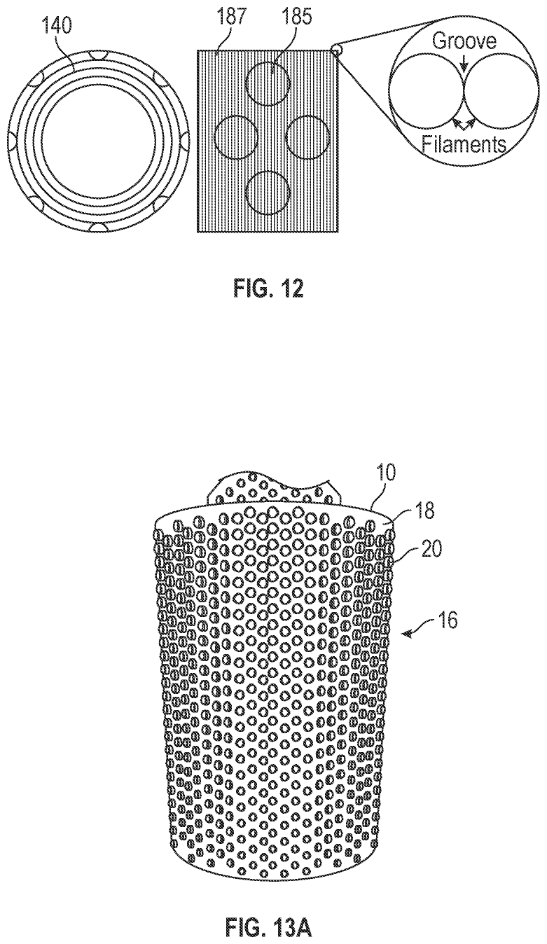

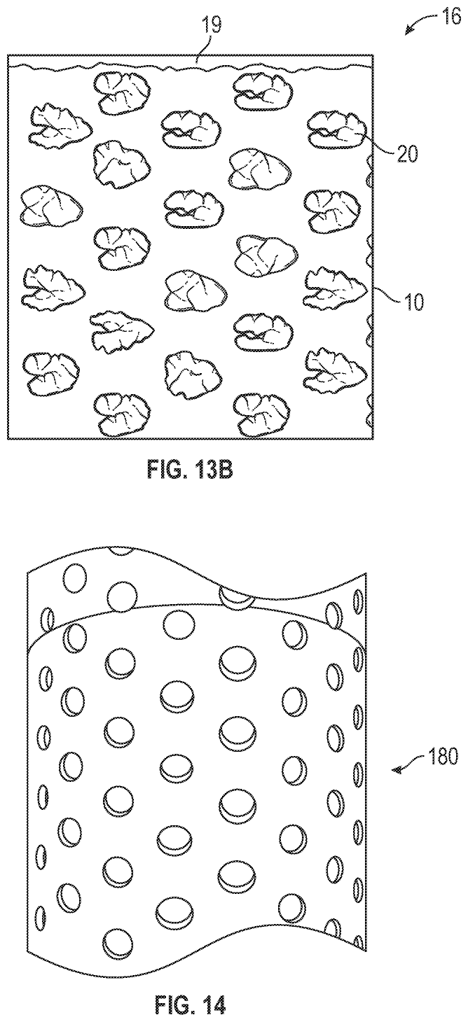

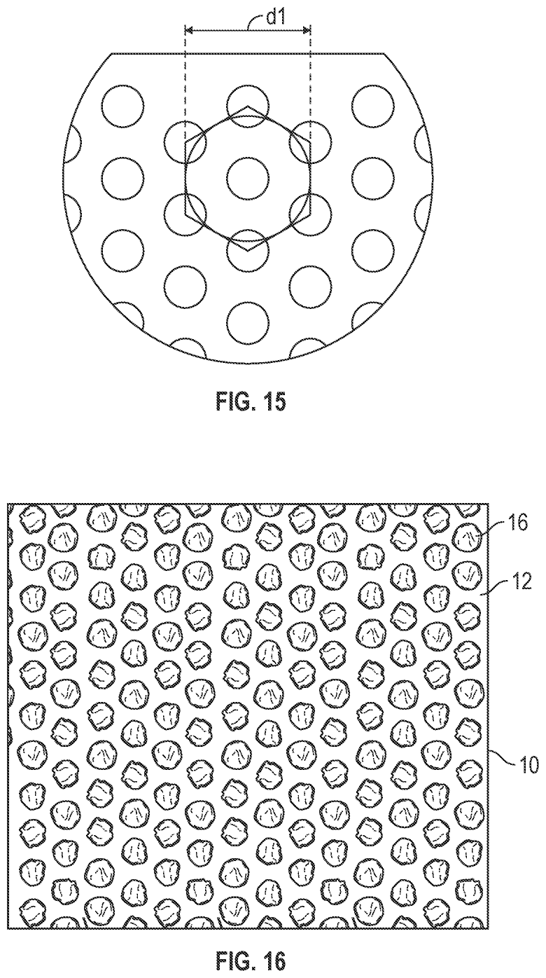

In other embodiments, the final foamed composition 16 can have a continuous or substantially continuous overall coating 18 on the first major surface 12 of the sheet material 10 and then a discontinuous pattern 20 comprising an array of discrete elements placed on top of the continuous coating such as shown in FIGS. 13A and 13B. As will be shown later in the Examples, utilizing both coatings layers can improve the heat-sealing capability of the foamed composition, since it has a continuous coating layer, while also having significant cushioning capability due to the discontinuous pattern coating layer. A rotogravure roll, as shown in FIG. 12, with appropriate cell patterns can apply both coating layers in a single printing pass. Alternatively, the different coating layers can be applied by two coating stations with different rotogravure rolls.

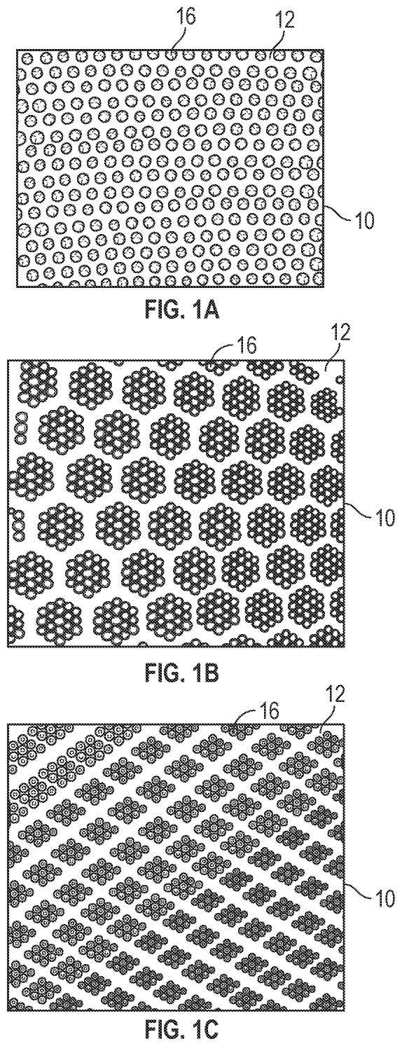

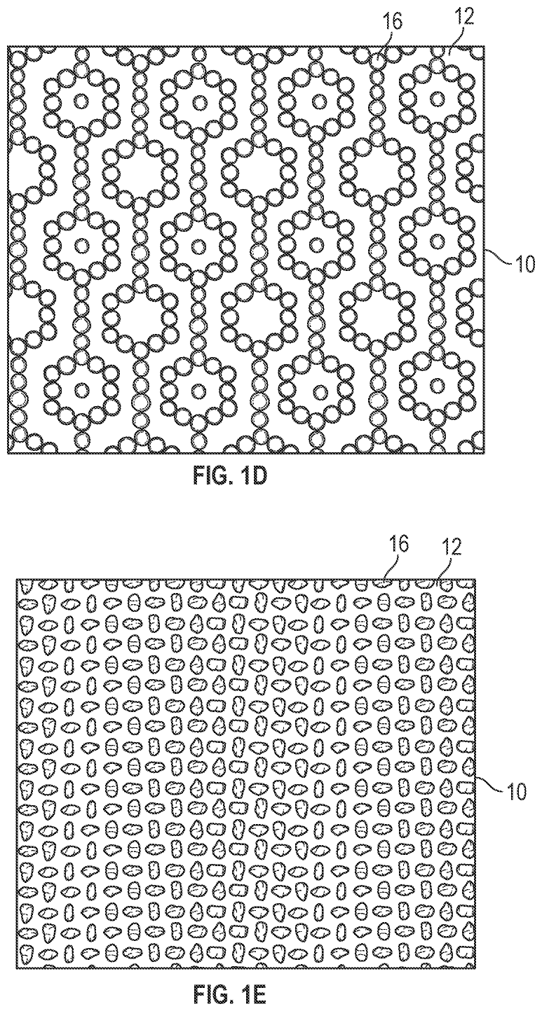

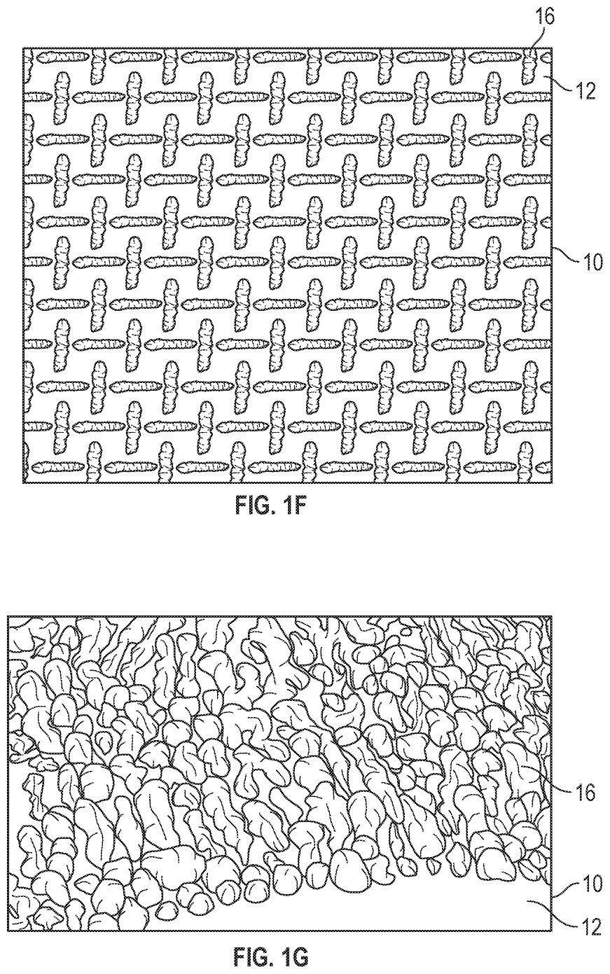

In a discontinuous pattern, spaces exist between the elements in the array of element. The pattern is chosen to allow for appropriate expansion of the expandable composition upon depositing on the substrate surface. Any chosen pattern may include one or more variations of spacings for expansion. For example, discrete areas of the composition may be used, which are unconnected or discontinuous to other discrete areas of the composition; or discrete areas of the expandable composition may be used in combination with connecting bridges between the discrete areas, such that they are connected but still provide expansion room. The discrete areas may be any shape or configuration to serve the purpose of providing a protective padding upon expansion. Such patterns may be regular or irregular (i.e., with a random array of elements). Nonlimiting examples of such patterns are shown in FIGS. 1A-1G. The pattern may be configured in various ways to fit the final product and provide the desired padding. For example, the pattern may be a series of linear or nonlinear spaced apart elements of the composition. These elements may be connected at one or more places or may be positioned in a parallel or nonparallel configuration or may form recognizable texts, images or logos, for example.

Each element of the array of discrete elements of foamed composition has a length and a width, typically with at least one dimension being in a range of 0.05 inch to 2.0 inches, (1.27 to 50.8 mm) and at least one dimensions being in a range of 0.1 inch to 2.5 inches (2.5 to 63.5 mm).

The substrate surface area may be 100% covered, but typically is less than 100% covered, by the discrete elements of the foamed composition (i.e., foam). In certain embodiments, the foamed composition covers at least 10%, at least 20%, or at least 30%, of the surface area of the substrate (e.g., sheet material). In certain embodiments, the foamed composition covers up to 100%, up to 90%, up to 80%, up to 70%, of the surface area of the substrate (e.g., sheet material). The coverage may be higher in certain areas than in others. For example, the coverage may be higher in an area on the substrate that will form a seal with another substrate (e.g., at edges of sheet materials that form the walls of an envelope). Alternatively, the coverage may be lower, or completely absent, in an area on the substrate (e.g., on a sheet material portion that forms a flap of an envelope). In certain embodiments, the foamed composition is disposed on the surface of the substrate (e.g., sheet material) in an amount (i.e., coating weight) of at least 5 grams per square meter (gsm), at least 10 gsm, at least 15 gsm, or at least 20 gsm. In certain embodiments, the foamed composition is disposed on the surface of the substrate (e.g., sheet material) in an amount of up to 120 gsm, up to 110 gsm, up to 100 gsm, up to 90 gsm, up to 80 gsm, up to 70 gsm, up to 60 gsm, up to 50 gsm, or up to 40 gsm. This can be determined using the Foam Weight Test described in the Examples Section.

In other embodiments where there is both a continuous foamed composition coating layer and a discontinuous foamed composition coating layer of discrete elements, the coating weight range of the continuous foamed coating can be from 0-50 gsm, from 5-30 gsm, or from 5-20 gsm. The weight range of the discontinuous discrete foamed elements can be from 5-100 gsm, from 10-80 gsm, or from 15-70 gsm. The total coating weight on the substrate would be the sum of the individual weight ranges.

In certain embodiments, the foamed composition (i.e., each element of the array of discrete elements of foamed composition) disposed on the surface of the substrate (e.g., sheet material) has a height of at least 0.25 mm, at least 0.5 mm, at least 1.0 mm, at least 2 mm, and often up to 10 mm or even up to 50 mm.

The foamed compositions may be exposed, or they may be covered or enclosed (at least partially) by one or more sheet materials (e.g., paper or other cover sheet) such that the foam padding material forms a “sandwich” with the foamed composition sandwiched between two sheet materials, which may be the same or different. Such foam padded materials may include, for example, paper/foam/paper or paper/foam/foam/paper constructions, and may be used in making multilayered padded mailing articles.

The recyclable and/or compostable padding material can be provided in any sizes and shapes Typically, it is provided in a roll form that can be easily cut into discrete lengths for forming into a packaging article, e.g., an envelope.

### Sheet Materials

In certain embodiments, the sheet materials of the foam padded materials and the walls of the packaging articles include recyclable materials. In certain embodiments, the recyclable materials are repulpable materials, such as paper. Preferably, the sheet materials of the foam padded materials and the walls of the packaging articles contain only repulpable paper, and thus are described as consisting of repulpable paper. The sheet materials of the foam padded materials and the walls of the packaging articles can be one material or more than one material, and the materials that constitute the first and second walls can be the same or different.

“Paper” as used in this context refers to woven or non-woven sheet-shaped products or fabrics (which may be folded, and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves.

Any form of paper can be employed, although it is preferred that the paper is repulpable (i.e., capable of being turned into pulp). Papers (or cellulosic fibers) are by nature pulpable but once the papers are treated, their recyclability depends on the amount of fibers separated during the repulping process; for example, in the USA, there is a Volunteer Standard specifying a minimum of 80% fibers recovery. This standard was created by a joint committee of the Fibre Box Association and the American Forest & Paper Association (AF&PA).

Exemplary paper sheet materials include Kraft liner paper, fibreboard, chipboard, corrugated boards, paper medium, corrugated medium, solid bleached board (SBB), solid bleached sulphite board (SBS), solid unbleached board (SLB), white lined chipboard (WLC), kraft paper, kraft board, coated paper, internally sized paper, binder board, or mixtures thereof. Examples of non-traditional products that are “paper” within the context of this disclosure include the material available under the trade designation TRINGA from PAPTIC (Espoo, Finland), and sheet forms of the material available under the trade designation SULAPAC. Kraft paper is particularly useful for this purpose, although other papers may be used.

Exemplary sheet materials that can be used have a basis weight that is sufficient to allow them to withstand weather conditions, such as heat, cold, rain, or snow, and other conditions and that may be encountered during a packaging and shipping process, as well as to withstand handling that may occur during packaging and shipping, such as dropping, jostling, banging against other objects, and the like. Any basis weight that is suitable for the intended use can be employed, and a variety of basis weights may be suitable depending on the needs of the users. Most commonly, the basis weight (in units of grams per square meter (g/m² or gsm)) will be at least 5, at least 10, at least 15, at least 20, at least 25, at least 30, at least 40, at least 45, at least 50, at least 55, at least 60, at least 65, at least 70 gsm. Most commonly, the basis weight (in units of g/m² (gsm)) will be up to 200, up to 150, up to 140, up to 130, up to 120, up to 110, up to 100, up to 75, up to 70, up to 65, up to 60, up to 55, up to 50, up to 45, up to 40, up to 35, up to 30, or up to 25 gsm. Most commonly, the basis weight employed (in units of g/m²) is 30 to 200 gsm.

In particular cases, a single sheet of material is folded to create both the first wall and the second wall out of the same sheet of material, which provides a first wall and a second wall that have the same constituents and are made of the same materials. This can be particularly advantageous for ease of assembly or manufacture of the packaging article. In such cases, one end or edge of the sheet can overlap the opposing end or edge of the sheet, forming a tube. The tube can be sealed by attaching the overlapping portions. The resulting tube can be open at both ends. It is possible to seal both of the final two openings after an object is placed within the packaging article, or it is possible to seal one opening, then place an object within the packaging article, and then seal the remaining opening. This can be accomplished by methods described herein or known in the art, for example, by use of a bag sealing machine, impulse sealer, heat sealer, or the like.

It is not required that the first wall and second wall be made of the same sheet of material. It is also possible to attach two sheets of different materials to make an article with a first wall and second wall that have different materials. This can be advantageous for some intended uses so embodiments that are assembled in this manner are also important. It is also possible to attach two sheets of the same materials rather than folding one sheet; while this is less common, it may be an important mode of practicing the disclosure for some intended uses of the packaging article.

The first wall, second wall, or both may be constructed from a single layer or sheet of material or from multiple sheets.

When multiple sheets (i.e., layers) are used for the first wall, second wall, or both, they can be the same or different layers or sheets. Two, three, four, or even more layers or sheets can be used. In a configuration where there are two layers or sheets, one sheet is an inner layer or sheet disposed on the interior of the applicable wall, and the other layer or sheet is an exterior layer of sheet disposed on the exterior of the applicable wall. In a configuration where there are three layers or sheets, and additional intermediate layer or sheet is present between the inner and outer layers or sheets.

One or more of the layers or sheets can be flat layers or sheets. It is also possible that one or more of the layers or sheets can be embossed (prior to depositing foam thereon). An embossed layer or sheet can provide some additional cushioning for the contents of the packaging article, and so can be advantageous for certain uses. Any embossment pattern can be used, but most often a regular or repeating pattern is employed. Examples of repeating patterns are diamonds, squares, circles, triangles, hexagons, as well as mixed patterns with different shapes. When multiple layers or sheets are used, any or all of the layers or sheets can be embossed. Most commonly, when two layers or sheets are used the interior layer or sheet is embossed and the exterior layer or sheet is not embossed. When three layers or sheets are used, then typically either the intermediate or interior layer or sheet is embossed and the other layers or sheets are not embossed. However, other configurations are possible. For example, it might be useful in a three-layer construction emboss both the interior layer or sheet and the intermediate layer or sheet in order to provide additional cushioning beyond what is provided with only one embossed layer or sheet.

Any of the layers or sheets may include a coating, which is deemed to be part of the layer or sheet. Suitable coatings, which may be selected depending on the requirements or ultimate intended use of the article, can include poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax, and most particularly poly(butylene succinate).

### Packaging Articles

Packaging articles, particularly those designed for shipping such as mailers, envelopes, bags, and pouches, are described herein.

The packaging article can take a variety of forms. For example, the article can be a pouch, a bag, a box, a mailer or an envelope. Still other forms are also possible. Regardless of its form article can be completely closed, for example with an object inside it, or it can have an opening. The article will typically have two walls, a first wall and a second wall, each having an interior surface facing the interior of the article and an exterior surface facing the exterior of the article. Thus, the interior surface of the first wall (the “first interior surface”) faces the interior surface of the second wall (the “second interior surface”).

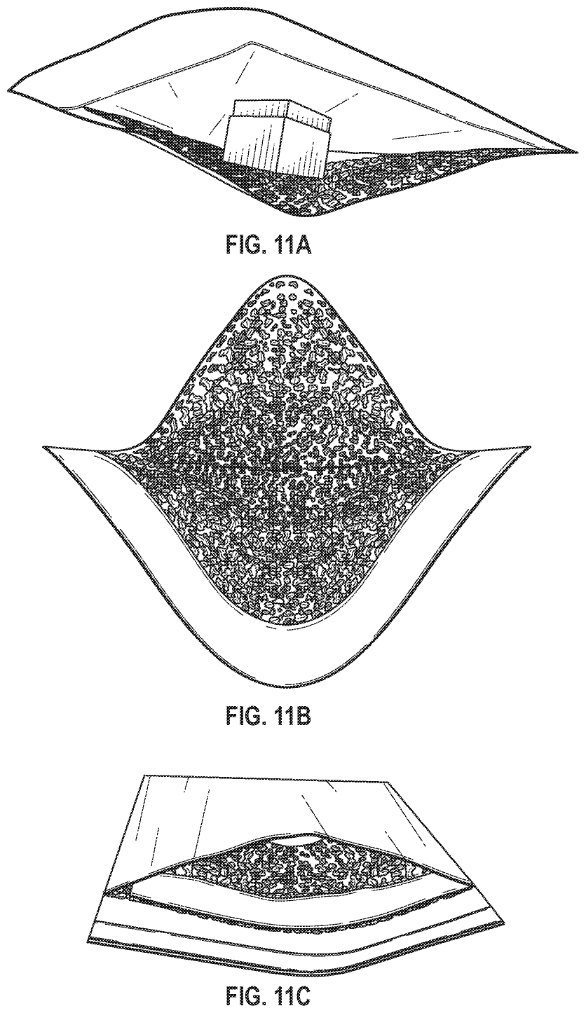

The interior surfaces of the walls, which as discussed above may be coated surfaces, are the surfaces of the sheet materials that include the foamed composition disposed thereon. The foamed composition can be exposed to the interior of the packaging article, in which case no further sheets or layers are disposed over the foamed composition. Alternatively, one or more further layers of sheet material can be disposed over the foamed composition in the form of one or more cover sheets. In those cases, the packaging article has a construction with the foamed composition sandwiched between two sheet or layers of materials. The cover sheets can comprise the same or different materials from the materials that make up the walls. Such walls may include, one layer of foam-coated sheet material plus a cover sheet or two layers of foam-coated sheet material, thereby forming, for example, paper/foam/paper or paper/foam/foam/paper constructions. Examples of such multilayered padded mailing articles are shown, for example, in FIGS. 11A-C. Such cover sheets may reduce the friction experienced by items inserted into a padded mailing article.

The two walls are typically made from a sheet of material, which may be a single layer of material or multiple layers of material. Each of the walls may be made of different sheets, in which case the two walls can be made from the same or different material. More commonly, the first and second walls are made of the same sheet of material that is folded to produce the two distinct walls. In these cases, the first and second walls can consist of the same materials.

The first wall and the second wall are attached along at least one edge of the packaging article. Depending on the configuration and shape of the article, they may be attached along two, three, four, or even more edges. The first wall and the second wall can be attached directly, such as being sealed together, or they may be attached indirectly by way of an intermediary structure such as a gusset, welt, or similar. The packaging article can also include an opening where the first and second walls are not attached.

The packaging article can include an opening where the first and second walls are not attached. However, openings are not required because it is also possible to form the packaging article around an object located in the interior thereby removing the need to make an article with an opening and subsequently close the opening.

The packaging articles include a foamed composition disposed on at least a portion of each of the first and second interior surfaces. The foamed composition may form a continuous or discontinuous coating, or a combination of the two coatings, on each of the first and second surfaces.

In certain embodiments, the foamed composition is disposed in a discontinuous pattern comprising an array of discrete elements. Such discrete elements can be in the form of a wide variety of geometric shapes, such as squares, rectangles, triangles, spirals, lines, circles, and the like. The spacing, size, density, etc. of the foamed composition that is disposed on the interior surfaces of the packaging article can be the same as described herein for the foam padded material.

When employed, the one or more cover sheets disposed over the foamed construction can be made of any suitable sheet material or layer. Most commonly, cover sheets are made from a paper or nonwoven sheet or layer. When paper is used the paper can be any type of paper, which will depend on the intended use, such as Kraft paper, bond paper, crepe paper, and the like. When a nonwoven is used it can be any sheet nonwoven, such as those made of polymers or copolymers of one or more of lactic acid, lactide, glycolic acid, glycolide, caprolactone, and the like. The one or more cover sheets can be coated on one or both sides, for example, with heat sealable coatings that can include, for example, poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax, and most particularly poly(butylene succinate).

When employed, the one or more cover sheets can be secured in place either by anchoring to the all or part of the foamed composition or, in cases where not all of the interior surface of the wall is covered by a foamed composition by anchoring to one or more portions of the interior surface of the wall that do not contact the foamed composition. This can be accomplished by laminating, heat sealing, adhesive, or the like, or, in the case where a cover sheet is anchored to the foam, by using the foamed composition itself as an adhesive, which can be accomplished by contacting a cover sheet with the foamed composition while the foamed composition has not completely set.

One or more cover sheets can be used. When cover sheets are employed, most commonly the interior surfaces of both walls are covered by the cover sheets. However, this is not required. It is to be understood that the use of cover sheets is optional.

The packaging articles of the present disclosure also include a sealing joint at one or more edges of the first and second walls. In most cases the sealing joint includes, or is formed from, the foamed composition, which attaches the first wall to the second wall.

In making a packaging article, the sheets can be bonded together in any suitable way to form a sealing joint at one or more edges of the sheet materials (e.g., that form the first and second walls of the packaging article). Preferably, the sealing joint can be formed using the foamed composition to attach the first wall to the second wall. Preferably, the foamed compositions as described herein can be heat-sealable compositions, in which case the sheets can be bonded together by a heat-sealing process, induction welding, ultrasonic welding, or impulse sealing. A patterned calendar roll or pressured roll can also be used to bond adjoining layers. Alternatively, the foamed compositions can be water-sealable compositions, thereby form a sealing joint upon the application of water.

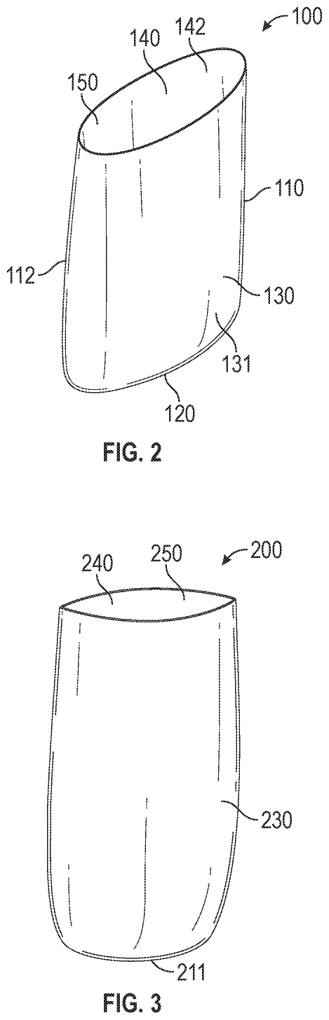

FIG. 2 shows one exemplary packaging article construction where two edges of the first and second walls are attached. In FIG. 2, article 100 is configured as a bag. First and second edges 110, 112 are attached directly, joining first wall 130 with second wall 140. Only the exterior surface 131 of first wall 130 and interior surface 142 of second wall 140 are visible in this figure. Opening 150 is present where the first and second walls 130, 140 are not attached. Bottom 120 is in this case defined by a fold in the sheet material that constitutes article 100.

FIG. 3 shows another construction where only one edge of the first and second walls are attached. Here, exemplary article 200 is also configured as a bag. A single edge 211 attaches most of first and second walls 230, 240 while leaving them unattached at opening 250.

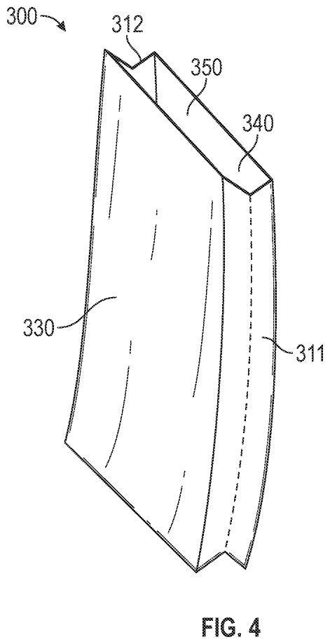

FIG. 4 shows a construction of exemplary packaging article 300 where edges 311, 312 are in the form of gussets that attach first and second walls 330, 340 while leaving opening 350 where the first and second walls 330, 340 are not attached.

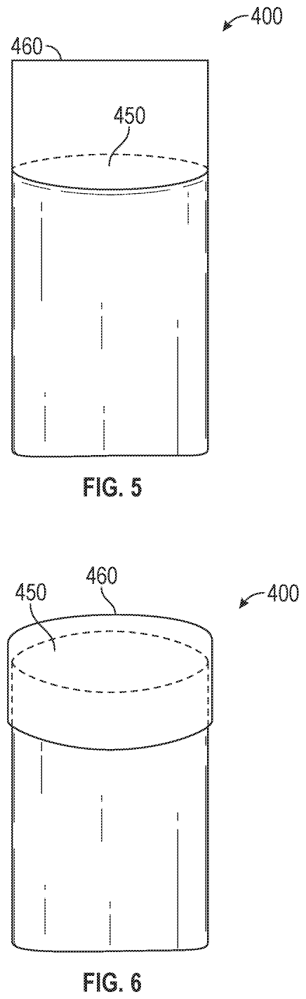

FIGS. 5 and 6 show another exemplary construction of packaging article 400, which contains flap 460, which is foldable between an open position, as shown in FIG. 5, and a closed position as shown in FIG. 6. In the open position opening 450 is uncovered, but in a closed position opening 450 is covered by flap 460.

### Adhesive Portions

In some embodiments, one or more adhesive portions can be provided. The adhesive portions are not considered to be part of the walls. Typically, when employed, the adhesive portions are near the opening in the packaging article, and can be used to close the article. If a flap is employed, the one or more adhesive portions are often on the flap, or on a portion of the exterior surface that can be reached by the flap when the flap is folded into the closed position, so as to allow the flap to be adhered into a closed position. In many cases two adhesive portions are provided.

The one or more adhesive portions are usually in the shape of a strip or strips that runs roughly parallel to the opening of the packaging article, but this is not required. For example, it is also possible to coat the adhesive portion or portions over one or more larger sections or portions of the articles, such as sections or portions of one or more walls or the flap (if a flap is employed).

The one or more adhesive portions can be any suitable adhesive depending on the desired use and are particularly recyclable, compostable, or recycle compatible, and most commonly recycle compatible. In this context, the term “recycle compatible” refers to materials or compounds that are not themselves recyclable but that are readily separated from recyclable materials during the recycling process, more particularly during repulping. Thus, a packaging article can have components, such as adhesive, that are not themselves recyclable and still be recyclable if the non-recyclable components are recycle compatible.

In particular cases, the one or more adhesive portions consist of recyclable and/or compostable adhesive. The one or more adhesive portions can be a water-activated adhesive, a heat sealable adhesive, a hot melt adhesive, or a pressure sensitive adhesive. Most particularly, a pressure sensitive adhesive is employed. Examples of suitable adhesives include a copolymer of 2-octylacrylate and acrylic acid; a copolymer of sugar-modified acrylates; a blend of poly(lactic acid), polycaprolactone, and resin; a blend of; poly(hydroxyalkanoate) and resin; protein adhesive; natural rubber adhesive; synthetic rubber adhesive; and polyamides containing dimer acid.

When a heat sealable adhesive is used, it can be any heat sealable or hot melt adhesive. Most commonly the heat sealable adhesive is one that can be sealed at a moderate or low heat by use of an impulse sealer, or heat sealer, for example, a handheld heat sealer. Many handheld heat sealers are commercially available both for home and commercial use, for example the Mini Bag Sealer from EEX Co., Ltd., and the iTouchless Handheld Heat Bag Sealer (available from Amazon, USA). Examples of heat sealable adhesives that can be used include poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax. Most particularly, poly(butylene succinate) (sometimes known as PBS) is employed.

One or more release liners can be disposed over any or all the one or more adhesive portions. While it is advantageous that the release liners be compostable and/or recyclable, this is not required because the release liners can be disposed of separately from the packaging article after use and do not have to be placed with the packaging article in a composting and/or recycling environment. Thus, if the packaging articles as described herein have one or more release liners, the packaging articles can be compostable and/or recyclable even if any or all of the release liners are not.

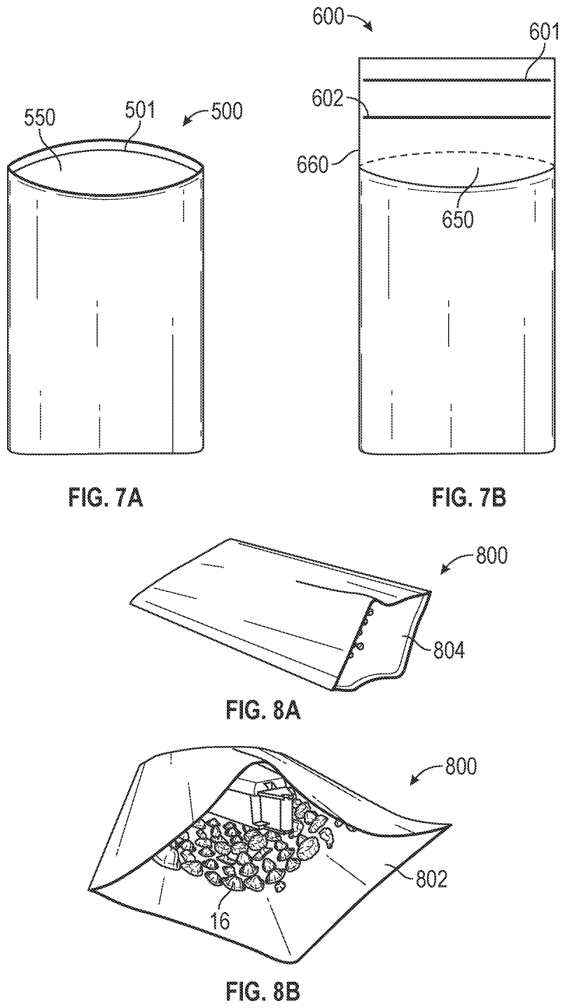

Exemplary packaging article 500 with adhesive portion 501 is shown in FIG. 7A. In this example, packaging article 500 is formed as a bag and adhesive portion 501 is disposed near the top of opening 550 to close opening 550 if desired.

Exemplary packaging article 600 with two adhesive portions 601 and 602 is shown in FIG. 7B. In this example, packaging article 600 is formed as a pouch and adhesive portions 501 and 602 are disposed on flap 660 to close opening 650.

FIGS. 8A and 8B are schematics of an exemplary packaging article, specifically an envelope 800 with an uncoated flap 802 (i.e., a portion of the wall material that forms the flap of the envelope with no foamed composition 16 disposed thereon) having an adhesive strip 804 disposed thereon for sealing of the flap when in a closed position.

When the article has one or more cover sheets, one or more adhesive portions can be on the cover sheets. For example, when a heat-sealable coating, such as poly(butylene succinate) is used as a coating on part or all of the cover sheets, the heat-sealable coating can serve as an adhesive portion.

### Mechanisms to Facilitate Opening

Mechanisms or features may be present to facilitate easy opening of the packaging article after it is sealed. Examples include perforations, scoring, zip-tops, or embedded pull-strings or wires. When an opening or flap is present, one or more of these features may be present near the opening or flap to facilitate opening the packaging article near the opening or flap, or they may be present on a different part of the packaging article. While these features, when employed, are most commonly in a straight line parallel to at least one edge of the packaging article no particular configuration is required; other shapes or layouts can be used depending on the intended use of the packaging article.

### Methods of Making and Assemblies

Assembly of the packaging articles as described herein can be performed by any suitable method.

One method of assembling the packaging article entails folding the one or more layers are sheets, which are bonded together when multiple layers or sheets are used, to form a first wall and a second wall. When the packaging article is a bag, they can be folded in half. When the packaging article is a pouch or envelope, they can be folded such that there is flap in the first wall that overhangs the edge of the second wall. The edges can then be attached, such as by heat sealing, ultrasonic welding, or impulse sealing, to form the packaging article. The procedure is similar when the first and second walls are made of different materials, as long as one wall has the foamed composition disposed therein, in which case all the edges besides the opening can be sealed to form the final article.

An assembly can be formed by placing an object in any packaging article as described herein. The packaging article can then be closed, for example, by folding the flap to a closed position and attaching it to an exterior surface with at least one of the one or more adhesive portions.

An assembly and packaging article can be formed together. For example, an object can be placed on the layers or sheets from which the article or assembly is to be formed. The article or assembly can then be folded around the object and the edges sealed completely around the object. This can result in an article or assembly wherein the object is in the interior of the packaging article or assembly, and the edges are sealed so that the object cannot fall out unless one or more seals are broken at the edges or one or more of the layers or sheets are punctured, cut, tom, or the like to make an opening.

### Resealing

When one or more adhesive portions are used on the flap, it is possible to reseal an open packaging article. For example, an assembly can be formed as discussed above and the packaging article can then be opened, for example, by tearing the flap of the packaging article at the perforated sealed adhesive portion or by tearing a seal of the cover sheet or sheets. At this point, an adhesive portion is available to reseal the packaging article. This procedure can be followed, for example, when an item that is shipped within the packaging article is to be returned to the sender within the same packaging article.

### Examples

The following illustrative examples may aid in understanding the disclosure. However, the disclosure is not necessarily limited to these examples. Embodiments and concepts that are not specifically exemplified may have been disclosed. Unless otherwise noted, all parts, percentages, ratios, etc. in the examples and the rest of the specification are by weight, and all materials used in the examples were obtained, or are available, from general suppliers such as, for example, Georgia-Pacific, Atlanta, GA, US.

TABLE 1
Materials

| Material | Description | Supplier |
|---|---|---|
| G-polymer | Water-soluble amorphous | Soarus LLC, Arlington |
| OKS-8074P | vinyl alcohol copolymer | Heights, IL, USA |
| | resin¹ | |
| DUR-O-SET | Polyvinyl alcohol stabilized | Celanese, Florence, |
| E-230 | vinyl acetate-ethylene | KY, USA |
| | copolymer aqueous emulsion, | |
| | 54% solids | |
| DUR-O-SET | Polyvinyl acetate | Celanese, Florence, |
| C-335 | homopolymer aqueous | KY, USA |
| | emulsion, 55% solids | |
| EXPANCEL | Expandable Microspheres | Nouryon Pulp and |
| 043 DU 80 | | Performance |
| | | Chemicals LLC, |
| | | Marietta, GA, USA |
| METHOCEL | Thickening agent | DuPont, Wilmington, |
| K4M | | DE, USA |
| Kraft Paper | 55-pound (81 gsm) basis weight | Ahlstrom Munksjö, |
| #085850 | natural MF Kraft paper | Kaukauna, WI, USA |
| 9925XL | Double Coated Tape with Liner | 3M Company, St. |
| | | Paul, MN, USA |

¹G-Polymer OKS-8074P is a polyvinyl alcohol copolymer believed to contain divalent monomer units of hydroxyethylene, 3,4-dihydroxybutan-1,2-diyl, and optionally acetoxyethylene

According to the supplier's literature, the melting temperature of the OKS-8074P G-polymer was 185° C., and the melt flow index (MFI) was 2.0-4.0 grams (g) per 10 minutes (min), as measured with a Melt Indexer at 210° C. with a 2160 g load.

### Test Methods

Brookfield Viscosity: Viscosity of the aqueous polymer dispersions was measured using a Brookfield DV-E Viscometer, while operating at 6 revolutions per minute (rpm) using spindle #7.
Foam Weight: The weight of the foam was measured using TAPPI T 410 OM-19, “Grammage of Paper and Paperboard (Weight per Unit Area).” A 10-centimeter (10-cm) by 10-cm (4-inches (4-in) by 4-in) square was cut from each foamed sample and was weighed and the total basis weight in gsm (grams per square meter) was calculated. To determine the coating weight of the foam only, the basis weight of the substrate was subtracted from the total basis weight.
Abrasion Resistance: Tests were performed using a Model 5750 Linear Abraser (Taber Industries, North Tonawanda, NY, USA) with a flat, smooth stainless steel attachment. The instrument had a free-floating horizontal arm that moved back and forth in a linear motion, and a vertical spline shaft was attached to the horizontal arm to allow weight to be added to the shaft. For each experiment, the samples were cut into approximately 3.81-cm by 10-cm (1.5-in by 4-in) strips. The test specimen was affixed to the bottom of the spline shaft so that the stainless steel attachment was touching the side of the sample containing the patterned foam elements. Tests were performed where the shaft was mounted with 3 weight discs, corresponding to subjecting the specimen to 1100 g of total weight exerted from the top. Each specimen is subjected to 30 cycles of abrasion, at a speed of 1 cycle/second to horizontal abraser arm movement. A fresh sample was used for each abrasion experiment, and the weight of the sample, as well as the weight of an uncoated piece of paper substrate, were measured before and after the abrasion experiment to calculate % loss as follows:

$$\\ \% loss due to foam shredding = \frac{weight after abrasion - weight before abrasion}{weight before abrasion - weight base paper}$$

Compression Strength and Energy Absorption and Loss: Quasi-static compression testing was completed using a MTS Alliance Load Frame (available from MTS, Eden Prairie, MN, USA). The foamed samples were cut into five specimens, each approximately 5.1-cm by 5.1-cm (2-in by 2-in). The original sample thickness was determined by pre-loading samples to 10 N. Specimens were compressed axially between two 40-millimeter (40-mm) parallel plates at a rate of 1 mm/min until 50% compression strain was reached (based on the original sample thickness), and then the plates were returned at a rate of 1 mm/min to the original position (0% compression strain). Displacement and force were recorded and used to construct compressive strain (%) vs. compressive stress curves for both the compression and return stages of the test. The absorbed energy was calculated from the area under the first stress-strain curve, and the energy lost was calculated as the difference between the areas under the first and second stress-strain curves. Compression strength was taken as the compression stress at 50% compression.
Water Solubility: Samples were subjected to water dissolution tests to quantify the percentage of recoverable content. The samples were cut into two specimens each approximately 5.1-cm by 5.1-cm (2-in by 2-in) and the weight of each specimen was measured and recorded. Then, the specimens for each sample were placed in a lidded glass jar with 500 g of deionized (DI) water, and subjected to heat and agitation in a heated shaker water bath (Aqua Pro Linear Shaker Bath, available from Grant Instruments, Beaver Falls, PA, USA) operating at 55.5° C. (130° F.) and at 100 strokes/minute. The samples were monitored for up to 6 hours to record the amount of time elapsed when the printed features visually detached from the paper substrate. After the heated soak, the glass jars were removed from the shaker and the paper substrates were removed with a tweezer and allowed to air dry. The contents of the glass jars were drained and filtered through a stainless steel wire cloth having 0.5-mm (0.02-in) openings and 57% open area (McMaster-Carr, Elmhurst, IL, USA) to remove excess water, and then dried in a 70° C. oven for 30 minutes (min). Then the dried remaining contents were weighed, and the % recoverable content from water dissolution was calculated as:

$$\\ \% recovered content = 1 - \frac{dry weight of content left in filter}{weight of original sample}$$

Seam Strength: The seam strength of sealed foam-padded mailing envelopes was determined using the procedures outline in ASTM F88/F88M, “Standard Test Method for Seal Strength of Flexible Barrier Materials.” Test specimens 2.5-cm (1-in) wide were cut from sealed mailing envelopes perpendicular to the seam, with at a length of at least 5.1 cm (2 in) of material on either side of the seam. Samples were conditioned overnight in a controlled temperature and humidity room at 22.8±1.1° C. (73.1±2° F.) and 50±2% relative humidity prior to testing. Specimens were loaded into a constant-rate-of-extension tensile tester (MTS ALLIANCE RT/50 TESTING MACHINE, Eden Prairie, MN, USA) with a 1000 N load cell at an initial jaw separation of 3.8 cm (1.5 in). The sample was pulled until seam separation using an extension rate of 25 cm/min (10 in/min), and the average peak load and total energy of six specimens per sample were recorded. The seam width was measured, and the seam strength was calculated as the peak load divided by the seam width.

### Sample Preparation Procedures

### Concentration/Foaming Temperature Study

Five hundred grams (500 g) of G-polymer was dissolved in 1167 g of DI water under mechanical stirring to prepare an aqueous dispersion having 30 wt-% solids. Aliquots of this dispersion were diluted further to yield dispersions each having 5 wt-%, 10 wt-%, 15 wt-%, 20 wt-%, and 25 wt-% solids. Five grams (5 g) of expandable microspheres (043 DU 80) was added to 100 grams of each of these polymer dispersions, followed by mixing for 10 minutes (min), such that the concentration of expandable microspheres in the dispersions ranged from 2 wt-% to 8 wt-%. Similarly, METHOCEL K4M thickening agent was added to each dispersion and mixed, with the final concentration of thickening agent in the dispersion ranging from 1 wt-% to 6 wt-%. After mixing, the 20 wt-%, 25 wt-%, and 30 wt-% copolymer dispersions had Brookfield viscosity values ranging from 1000 to 70,000 centipoise (cP) at 25° C.

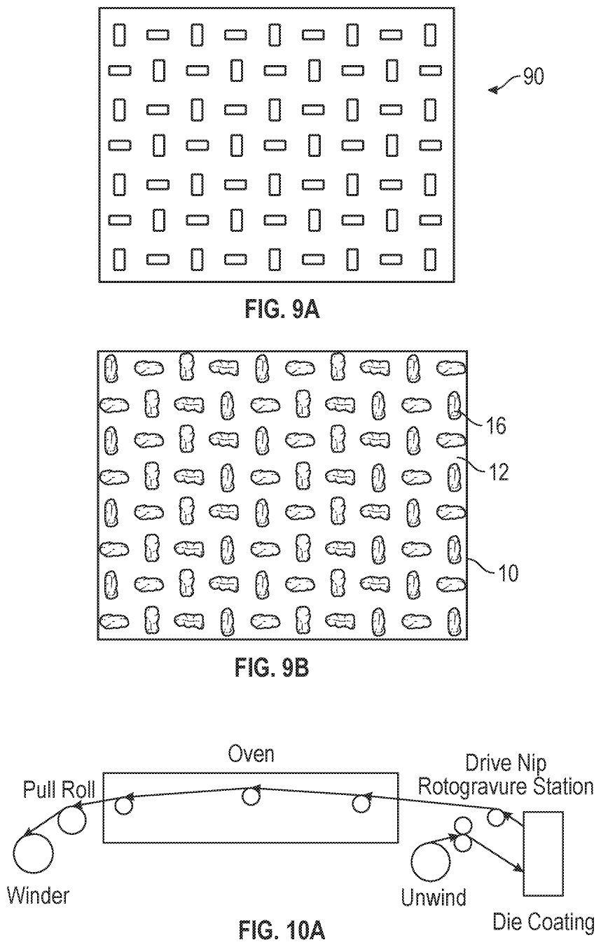

Each of the dispersions was deposited on 55-pound Kraft paper using a 30.5 cm by 30.5 cm (12 inches (in) by 12 in) hand stencil as shown in FIG. 9A, then placed in an oven at either 105° C. or 170° C. Samples were evaluated for two attributes: whether a foam was achieved, and whether the resulting foam remained on the substrate or exhibited shedding or flaking when rubbed manually. Results are summarized in Table 2. All formulations foamed well at 105° C., but the foam shed easily when rubbed by hand. All formulations foamed well at 170° C., but the foamable compositions having 20 wt-% or great solids did not exhibit shedding or flaking under manual abrasion.

TABLE 2
Composition/Temperature Study Results

| Foaming | Weight % Solids in Copolymer Dispersion | | | | | |
|---|---|---|---|---|---|---|
| Temperature | 5 | 10 | 15 | 20 | 25 | 30 |
| 105° C. | foamed | foamed | foamed | foamed | foamed | foamed |
| | well, shed | well, shed | well, shed | well, shed | well, shed | well, shed |
| | easily | easily | easily | easily | easily | easily |
| 170° C. | foamed | N/A¹ | N/A¹ | foamed well, | foamed well, | foamed well, |
| | well, shed | | | no shedding | no shedding | no shedding |
| | easily | | | | | |

¹not tested

### Preparation of Foamable Compositions

Formulations of the foamable compositions are summarized in Table 3A. Five hundred grams (500 g) of G-polymer was weighed and dissolved in 1500 g of DI water under mechanical stirring to prepare an aqueous dispersion having 25 wt-% solids. For Formulations 2 and 4, 100 g of DUR-0-SET E230 emulsion was added to 100 g of 25% G-polymer dispersion and mixed. The appropriate amount of expandable microspheres was then added to 200 grams of the polymer dispersion and mixed for 10 mins. Thickening agent was added in the appropriate amount and mixed for another 10 min. To prepare Comparative Formulation 5, expandable microspheres and thickener were added to DUR-O-SET C-335 emulsion and mixed for 10 m. Table 3B summarizes the compositions of the materials after foaming and drying using the procedures that follow.

TABLE 3A
Formulations of Foamable Compositions (amounts
provided in % by weight of wet composition)

| | Form. | Form. | Form. | Form. | Comp. |
|---|---|---|---|---|---|
| Component | 1 | 2 | 3 | 4 | Form. 5 |
| G-polymer OKS-8074P, | 89 | 46.5 | 94 | 47 | 0 |
| 25% solids aqueous | | | | | |
| dispersion | | | | | |
| DUR-O-SET E-230 | 0 | 46.5 | 0 | 47 | 0 |
| copolymer emulsion | | | | | |
| DUR-O-SET C-335 VAE | 0 | 0 | 0 | 0 | 89 |
| homopolymer emulsion | | | | | |
| Expandable | 5 | 5 | 5 | 5 | 5 |
| Microspheres | | | | | |
| METHOCEL K4M | 6 | 2 | 1 | 1 | 6 |
| thickener | | | | | |

TABLE 3B
Compositions of Foamed Materials (amounts
provided in % by weight of dry foam)

| | Form. | Form. | Form. | Form. | Comp. |
|---|---|---|---|---|---|
| Component | 1 | 2 | 3 | 4 | Form. 5 |
| G-polymer OKS-8074P | 66.9 | 26.6 | 79.7 | 27.2 | 0 |
| DUR-O-SET E-230 | 0 | 57.4 | 0 | 58.8 | 0 |
| copolymer | | | | | |
| DUR-O-SET C-335 VAE | 0 | 0 | 0 | 0.0 | 81.7 |
| homopolymer | | | | | |
| Expanded Microspheres | 15.0 | 11.4 | 16.9 | 11.6 | 8.3 |
| METHOCEL K4M | 18.0 | 4.6 | 3.4 | 2.3 | 10.0 |
| thickener | | | | | |

### Screen Printing and Foaming—Examples 1, 2, and Comarative Example CE5

Formulations 1 and 2 were used to prepare padded foam sheet Examples 1 and 2, respectively, and Comparative Formulation 5 was used to prepare Comparative Example CE5. The foamable formulations were each screen printed onto sheets of 55-lb Kraft paper using the hand stencil 90 illustrated in FIG. 9A. The percentage open area of the template was 10% and the bars each measured 4 mm long by 1.5 mm wide and 1 mm thick and each cell was spaced 15 mm apart. The mixture was poured onto one edge of the template then a squeegee was used to pull the mixture across the stencil, filling the voids and transferring to the substrate. The stencil was then removed, and the coated paper was placed in a convection oven at 170° C. for 4 minutes to form the foamed composition 16 shown in FIG. 9B.

### Random Pattern Printing and Foaming—Examples 3A, 3B, 4A, and 4B

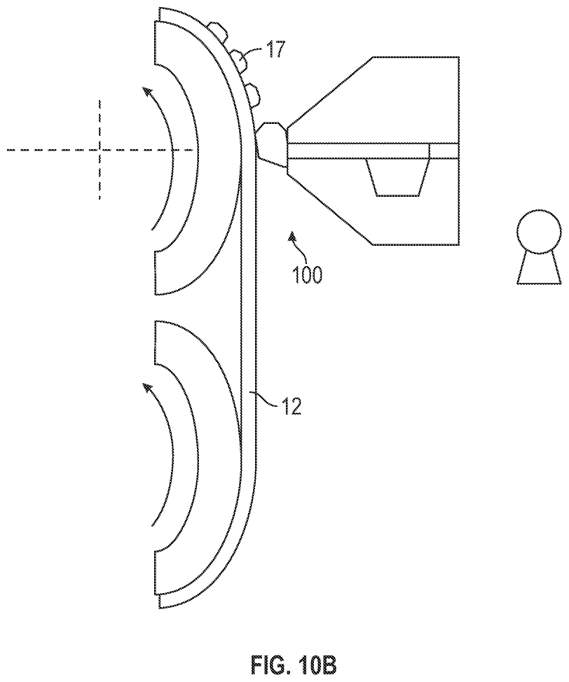

Formulation 3 was used to prepare padded foamed sheet Examples 3A and 3B, Formulation 4 was used to prepare padded foamed sheet Examples 4A and 4B. The foamable formulations were deposited onto a roll of 55-lb Kraft paper using the processes shown in FIGS. 10A and 10B. The Kraft paper substrate reel was placed on an unwind station as shown in FIG. 10A. The paper was fed into the rotogravure station and the drive nip was closed. A pneumatic motor was used to adjust the web speed of the paper substrate to approximately 2.4 meters per minute (m/min; 8 ft/min) as it was fed into the die coating station.

A schematic of the die coating station 100 used to coat Examples 3A and 4A is shown in FIG. 10B. A standard extrusion die similar to a PREMIERE fixed lip slot die (available from Nordson Corp., Westlake, OH, USA), was used to periodically deposit adhesive onto the Kraft paper substrate 12 as it moved through the coating station. The height of the extrusion die slot was controlled with a shim of thickness 0.51 mm (0.02 in). The width of the die slot was 28 cm (11 in). The lengths of both the upstream and downstream die lips were 0.51 mm (0.02 in). The upstream die lip is coplanar with the downstream die lip. The aqueous coating formulation was placed in a 0.95 liter (32 oz) plastic SEMCO dispensing cartridge (available from Fishman Corp., Hopkinton, MA, USA). The filled cartridge was place in a dispensing system similar to a SEMCO model 550 Sealant Gun (available from Fishman Corp., Hopkinton, MA, USA). To initiate periodic coating, the drive nip was engaged on the coating line to move the web. The die was positioned near the moving substrate at a gap of 0.13 mm (0.005 in). The die was positioned such that the center of the die slot was at the same height as the center of the axis of rotation of the back-up roll, as shown in FIG. 10B. The die slot was held horizontal as indicated by a bubble level. The dispensing system was engaged and operated to deliver an adhesive flow rate of 20 cc/min. The gap between the downstream die lip and the substrate, during adhesive deposition, was increased from 0.127 mm (0.005 in) to approximately 0.762 mm (0.03 in) to transition from continuous film coating to controlled random deposition of coating 17 (prior to drying and expansion). The die gap was further increased to approximately 1.5 mm (0.06 in) as the flow rate of adhesive was increase to 40 cubic centimeters per minute (cc/min).

For Examples 3B and 4B, a sheet of 0.254 mm (10 mil) thick polyester sheet was cut into a shim having 12.7 mm (0.5 in) wide teeth spaced 12.7 mm (0.5 in) apart. The shim was placed within the dies slot during coating to yield a striped pattern wherein each stripe consisted of randomly placed dots.

The coated paper exited the die coating station and was fed into a single zone oven set to 182° C. (360° F.) (available from Drying Systems Company, Morton Grove, IL, USA). The coated substrate travelled through the 2.74 m (9 ft) length of the oven supported on idler rolls. A rubber covered, pneumatic driven pull roll moved the substrate from the oven and sent it to a winder where the dried, coated substrate was wound into reels.

### Construction of Foam Padded Envelops

Table 4 summarizes the materials and construction procedures used to prepare exemplary foam-padded mailing containers. For Procedure A, sheets of foam-coated Kraft paper were cut to dimensions of approximately 30.5 cm (12 in) wide by 61 cm (24 in). Each sheet was folded with the foam-coated side toward the inside and was heat sealed along the edges using a Model iS2-20-20″ Impulse Sealer (available from IMPAK Corporation, Sebastian, FL, USA) set at 204° C. (400° F.) for 0.5 secs at a pressure of 345 kilopascals (kPa; 50 psi) to form a flat sealed mailing container approximately 30.5 cm (12 in) wide by 30.5 cm (12 in) long with an opening at one end.

For Procedure B, sheets of foam-padded Kraft paper were prepared as described above, except that a 6.4 cm (2.5 in) wide portion along the edge was left uncoated (i.e., had no foam padding). Sheets were cut to initial dimensions of approximately 37 cm (14.5 in) wide by 61 cm (24 in) long, with the uncoated section running along the long edge. Half of the uncoated portion was removed, and the sheet was folded with the foam-coated side toward the inside to form an overlapping area approximately 30.5 cm (12 in) wide by 30.5 cm (12 in) long, with a protruding flap that was about 6.4 cm (2.5 in) long. An uncoated (i.e., as received) sheet of Kraft paper approximately 29.2 cm (11.5 in) wide by 29.2 cm (11.5 in) long, was inserted between the walls of the folded structure to act as a smooth cover sheet along one wall of the padded mailing article (as shown in FIG. 11A). The article was heat sealed along the side edges and along the edge of the flap using the procedures described for Procedure A. A strip of 9925XL tape was then applied to the flap parallel to the edge and approximately 0.95 cm (0.38 in) from the edge, and the release liner was left on the adhesive strip.

Procedure C was similar to Procedure B, except that the paper cover sheet did not cover the entire wall of the mailer (as shown in FIG. 11B). Prior to heat sealing, an uncoated sheet measuring approximately 29.2 cm (11.5 in) wide by 7.6 cm (3 in) long, was inserted between the walls and was aligned with the top edge of the flap. The article was heat sealed along the side edges and along the edge of the flap using the procedures described for Procedure A. A strip of 9925XL tape was then applied to the flap parallel to the edge and approximately 0.95 cm (0.38 in) from the edge, and the release liner was left on the adhesive strip.

For Procedure D, sheets of foam-padded Kraft paper were prepared as described for Procedure B, with an uncoated edge portion (as shown in FIG. 11C). Sheets were cut to initial dimensions of approximately 37 cm (14.5 in) wide by 61 cm (24 in) long, with the uncoated section running along the long edge. Half of the uncoated portion was removed, and an uncoated sheet of Kraft paper approximately 6.4 cm (2.5 in) wide by 58 cm (23 in) long was placed lengthwise on top and aligned with the cut away portion. The uncoated paper was heat sealed (using the procedures described for Procedure A) to the foam-padded paper along the long edge, and the sheets were folded with the foam-coated side toward the inside to form an overlapping area approximately 30.5 cm (12 in) wide by 30.5 cm (12 in) long, with a protruding flap about 6.4 cm (2.5 in) long. The uncoated paper formed a short cover sheet around the inside of the opening of the mailing article. The article was heat sealed along the edges using the procedures described for Procedure A. A strip of 9925XL tape was then applied to the flap parallel to the edge and approximately 0.95 cm (0.38 in) from the edge, and the release liner was left on the adhesive strip.

Procedure E was similar to Procedure B, except that the cover sheet was an additional sheet of foam-padded paper instead of uncoated paper. Prior to heat sealing, an additional sheet of foam-padded paper approximately 29.2 cm (11.5 in) wide by 29.2 cm (11.5 in) long, was inserted between the walls of the folded structure such that the foamed side was facing the long side of the folded and the insert was aligned with the top edge of the flap. The article was heat sealed along the side edges and along the edge of the flap using the procedures described for Procedure A. A strip of 9925XL tape was then applied to the flap parallel to the edge and approximately 0.95 cm (0.38 in) from the edge, and the release liner was left on the adhesive strip.

TABLE 4
Composition and Construction of
Exemplary Foam-Padded Containers

| Foam-Padded Mailer | Foamed | Construction |
|---|---|---|
| Envelope Ex. No. | Sheets | Procedure |
| Example 5A | Example 1 | A |
| Example 5B | Example 1 | B |
| Example 6A | Example 3A | A |
| Example 6B | Example 3A | B |
| Example 6C | Example 3A | C |
| Example 6D | Example 3A | D |
| Example 6E | Example 3A | E |
| Example 7A | Example 4A | A |
| Example 7B | Example 4A | B |
| Example 7C | Example 4A | C |
| Example 7D | Example 4A | D |
| Example 7E | Example 4A | E |

### Results

Coating weight and overall sample thickness of foam-padded materials is provided in Table 5. To calculate coating weight, the basis weight of the Kraft paper was assumed to be 81 gsm. The total thickness of the foam and paper was measured using simple calipers, and the thickness of the uncoated Kraft paper was 0.14 mm (5.5 mil).

TABLE 5
Dimensions of Foam-Padded Materials

| | | Total Thickness of Paper + |
|---|---|---|
| | Coating Weight (gsm) | Foam (mm) |
| Example 1 | 11.39 | 1.458 |
| Example 2 | 15.35 | 1.536 |
| Example 3A | 23.33 | 1.446 |
| Example 3B | 14.88 | 2.492 |
| Example 4A | 26.58 | 2.036 |
| Example 4B | 24.03 | 2.6 |
| CE1 | 25.96 | 2.574 |

Compression test results (specifically, compression strength, stored energy and energy lost) were used to estimate impact and cushioning performance of foamed padded materials of the instant invention. Table 6 compares the compression test performance parameters of padded foam-coated sheets of Example 4 to two commercially available padded mailing envelopes. Comparative Example CE2 was a padded mailing envelope with foam between 2 layers of paper (ECO MAILER™ available from Technical Machinery Solutions (TMS), Elk Grove Village, IL USA) and Comparative Example CE3 was a paper-covered plastic bubble mailer (SCOTCH 7972-100-CS, 3M Company, St. Paul, MN, USA). Examples 1-4B, each having only a single paper layer, showed comparable compressive strength to CE2, which contained a double layered construction. Examples 1-4B demonstrated a higher energy loss compared to both CE2 and CE3, which is interpreted to mean that Example 4 is better able to absorb impact forces than both comparative materials. Examples 1-4B also showed a higher percentage of energy loss to energy absorbed than both CE2 and CE3, which is interpreted to mean that Example 4 is better able to dissipate impact forces over both comparative materials.

TABLE 6
Compression Test Results

| | Stress at 50% | Energy | Ratio of Energy Lost |
|---|---|---|---|
| | Compression (kPa) | Lost (kJ) | to Energy Absorbed (%) |
| Example 1 | 11.16 | 139 | 82.0 |
| Example 2 | 11.12 | 148.6 | 78.6 |
| Example 3A | 17.52 | 244.2 | 78.6 |
| Example 3B | 8.88 | 112.6 | 76.4 |
| Example 4A | 11.88 | 145.4 | 76.6 |
| Example 4B | 11.22 | 152 | 78.6 |
| CE1 | 23.04 | 271.6 | 84.8 |
| CE2 | 17.73 | 167.5 | 50.25 |
| CE3 | 39.55 | 145.25 | 19.75 |

Abrasion test results are summarized in Table 7 and were used to assess the durability of the foam coated samples. Examples 1 and 4A showed significantly less weight loss of foam after abrasion. In addition, it was observed that after abrasion, although the printed features on Examples 1 and 4A were significantly flattened, the features primarily remained attached to the paper substrate. In contrast, the printed features on CE1 appeared brittle and the top layer was removed due to the abrasion.

Results of the water dissolution test are also shown in Table 7. Examples 3A and 4A both show a higher amount of recovered content than CE1, which is indicative that the foamed compositions of the present invention are more water soluble than CE1, which was prepared using a homopolymer rather than a copolymer.

TABLE 7
Taber Abrasion and Water Dissolution Test Results

| | Exam- | Exam- | Exam- | |
|---|---|---|---|---|
| | ple 1 | ple 3A | ple 4A | CE1 |
| Foam loss after 30 cycles | 0.79% | N/A¹ | 5.8% | 37.5% |
| Weight % Recovered Content | N/A¹ | 99.0% | 87.7% | 83.9% |

¹not tested

Results of the seam strength test for padded foam packaging article Examples 5A, 6A, and 7A and Comparative Examples CE2 and CE3 are summarized in Table 8. Examples 5A, 6A, and 7A were heat sealed without the use of an additional adhesive. The foam itself acted as an adhesive, and exhibited a seam strength comparable to CE2, which included a seam adhesive.

TABLE 8
Seam Strength Test Results

| | Ex. 5A | Ex. 6A | Ex. 7A | CE2 | CE3 |
|---|---|---|---|---|---|
| Peak load (lb) | 0.66 | 0.68 | 1.25 | 1.1 | 3.3 |
| Seam width (in) | 0.5 | 0.5 | 0.5 | 0.5 | 0.5 |
| Seam Strength (lbf/in) | 1.32 | 1.36 | 1.25 | 2.2 | 6.6 |

### Rotogravure Printing of the Foamable Composition—Examples 6G-10G

The formulation of Example 1G was used to prepare the padded foamed sheet of Example 6G. The Kraft paper substrate roll was placed on the unwind shown. The paper was fed into a rotogravure printing station and the drive nip was closed. A pneumatic motor was used to adjust the web speed of the paper substrate to approximately 2.4 meters per minute (m/min; 8 ft/min) as it was fed into the rotogravure station. The coated paper was passed through an oven set at 360° F. (182° C.)

The foamable composition was deposited onto a roll of 55-lb Kraft paper using the processes using a rotogravure printing station that was fitted with a gravure roll sleeve with dimensions 7.62 cm inside dimeter and a 10.3 cm outer diameter by 35.5 cm long that was 3D printed using Stratasys F370 FDM printer using ABS filament, 0.007″ layer height and placed onto a 7.6 cm metal shaft to form a gravure roll 180 with cells 2 mm deep positioned around the diameter as illustrated in FIG. 14. The land area between the cells of the 3D printed sleeve were 1.03 cm. The roll's pattern is described in Table 9 as gravure pattern 2.

An unexpected benefit of 3D printing to make the gravure roll was that the 3D printing process left the surface of the roll with circumferential ridges and valleys. A machined gravure roll in metal would ordinarily be perfectly smooth in the land areas between the large circular holes that form the discrete elements. Thus, in addition to foamable composition printing of the discrete foamed elements, the surface of the substrate was also printed with closely spaced lines that once foamed, created a continuous foamed coating layer on the substrate. The continuous foamed layer significantly increases the seam strength of the heat-sealed packaging articles, such as mailers and envelopes, and is believed to strengthen the durability of the discrete foamed elements by more firmly anchoring them to the substrate.

The resulting foamed coating, using the gravure roll of FIG. 14, on the substrate is shown in FIGS. 13A and 13 B. As seen in FIG. 13B, the printed lines from the 3D printed gravure roll show up as faint lines in the continuous coating layer between the discrete elements. The continuous coating layer ends near the edge of the substrate 10 leaving an uncoated area 19 and then only the surface of the kraft paper is present. The foamable composition in this embodiment was dyed to match the color of the kraft paper to be more visually appealing.

In one embodiment, the weight of the total coating added was 38.1 gsm. The weight of the discrete elements was 18 gsm and the weight of the continuous coating was 20 gsm. In a second embodiment the total coating weight was 66.1 gsm, the discrete elements coating weight was 39.4 gsm, and the continuous coating weight area was 26.8 gsm. The range of the continuous foamed coating can be from 0-50 gsm, from 5-30 gsm, or from 5-20 gsm. The range of the discontinuous discrete foamed elements can be from 5-100 gsm, from 10-80 gsm, or from 15-70 gsm. The total coating weight would be the addition of the previous individual ranges.

Referring now to FIG. 12, the concept of printing the foamable composition onto the substrate with a gravure roll having both discrete circular elements 185 and a plurality of micro groves 187 to form a continuous foam coating is shown. The discrete elements are formed by large circular apertures arranged intro a parallelogram pattern that places the foamed discrete elements into rows of angled lines with respect to the edge of the substrate. The continuous coating layer is laid down by circumferential grooves in the roll's land areas between the apertures. This can be achieved by 3D printing closely spaced circumferential lines or filaments onto the rolls surface. Since the composition foams after application, laying down the foamable composition into discrete lines forms a substantially continuous coating on the substrate once the composition foams. Rather than 3D print the gravure roll, a machined roll having similar features could also be constructed.

The gravure roll coating approach enables a continuous foamed coating between the discrete foamed elements. This continuous coating provides a continuous heat sealable layer across the entire surface. This continuous coating substantially increased seam seal strength when heat sealing. The resulting seam seal strength of gravure roll coated samples in Table 14 ranges from 3.5 kgf/cm to 4.5 kgf/cm. For various embodiments, the seam seal strength is at least 0.5 kgf/cm, 1.0 kgf/cm, or 1.5 kgf/cm.

Dye was added to foamable composition in order to match the foam's color to that of the kraft paper onto which it is being coated. The dyed coating created a good color match between the discrete elements, the continuous coating layer and the kraft paper resulting in a visually appealing article. In some embodiments, the concentration of the dye ranges from 0.01% to 5.0% weight percent.

TABLE 9
Rotogravure Roll Patterns

| | Cell Depth | Cell Width | Cell Spacing d1 |
|---|---|---|---|
| Gravure Pattern | (mm) | (mm) | (mm) |
| 1 | 2 | 4 | 21 |
| 2 | 2 | 7 | 30 |
| 3 | 2 | 8 | 22 |

TABLE 10
Additional Materials

| Material | Description | Supplier |
|---|---|---|
| Styrenated Acrylic | Brown Aqueous | Penn Color, Doylestown, PA |
| 32N711 | Dispersion | USA |

TABLE 11
Additional Formulations Wet Weight

| | | G | | | Styrenated | |
|---|---|---|---|---|---|---|
| | Duroset | polymer | | | Acrylic | |
| | 54% | 25% | Expancel | | 60% | |
| | solids | solids | DU80 | Methocel | solids | Water |
| Formulation | (g) | (g) | (g) | (g) | (g) | (g) |
| 6G | 47.0 | 47.0 | 3.5 | 1 | 1.7 | 14.6 |
| 7G | 47.0 | 47.0 | 5.0 | 1 | 1.8 | 17.2 |
| 8G | 22.3 | 58.0 | 5.0 | 1 | 1.8 | 30.5 |
| 9G | 22.3 | 58.0 | 3.5 | 1 | 1.7 | 27.9 |
| 10G | 47.0 | 47.0 | 3.5 | 0 | 1.0 | 12.9 |

TABLE 12
Additional Formulations Dry Weight

| | | G | | | | |
|---|---|---|---|---|---|---|
| | Duroset | polymer | | | | |
| | 54% | 25% | Expancel | | Styrenated | |
| | solids | solids | DU80 | Methocel | Acrylic | Water |
| Formulation | (g) | (g) | (g) | (g) | (g) | (g) |
| 6G | 25.4 | 11.8 | 3.5 | 1 | 1.0 | 14.6 |
| 7G | 25.4 | 11.8 | 5.0 | 1 | 1.1 | 17.2 |
| 8G | 31.6 | 5.6 | 5.0 | 1 | 1.1 | 30.5 |
| 9G | 31.6 | 5.6 | 3.5 | 1 | 1.0 | 27.9 |
| 10G | 25.4 | 11.8 | 3.5 | 0 | 0.6 | 12.9 |

TABLE 13
Resulting Foam Basis Weights

| | | | | Discrete | |
|---|---|---|---|---|---|
| | | | Total | Elements | Continuous |
| | | | Coating | Coating | Coating |
| | | Gravure | Basis Wt | Basis Wt | Basis Wt |
| Sample | Formulation | Pattern | (gsm) | (gsm) | (gsm) |
| 1G | 6G | 1 | 17.2 | 10.2 | 7.0 |
| 2G | 6G | 2 | 27.7 | 17.1 | 10.6 |
| 3G | 7G | 2 | 21.2 | 15.0 | 6.2 |
| 4G | 8G | 2 | 29.4 | 16.2 | 13.2 |
| 5G | 9G | 2 | 38.1 | 18.1 | 20.0 |
| 6G | 10G | 2 | 25.6 | 16.6 | 9.0 |
| 7G | 10G | 3 | 66.2 | 39.4 | 26.8 |

TABLE 14
Resulting Seam Strength Continuous
Coating with Discrete Elements

| | Peak Force | Seam Width | Seam Strength |
|---|---|---|---|
| Sample | (lb) | (in) | (lbf/in) |
| 2G (33) | 0.86 | 0.5 | 1.72 |
| 3G (34) | 0.93 | 0.5 | 1.86 |
| 4G (37) | 0.84 | 0.5 | 1.68 |
| 5G (41) | 0.88 | 0.5 | 1.77 |
| 6G (49) | 0.83 | 0.5 | 1.66 |

Comparing the results of Table 8 to Table 14 show that a substrate having both a continuous or substantially continuous foamed coating layer combined with a discontinuous foamed coating layer of discrete elements significantly improved the heat-sealed seam strength of the packaging article. In particular, the seam strength increased from a range of 1.25-1.32 lbf/in to a range of 1.66-1.86 lbf/in which helps significant when forming heat sealed padded mailers utilizing the foamable composition in the seam to seal the edges. Since the padded substrate had a sufficient pattern for the discrete elements like the prior Examples, it also will have good cushioning properties when used for packaging.

The foam coated substrate with a continuous foam layer and discrete foamed elements can be formed into any of the packaging articles depicted in FIG. 2, 3, 4, 5, 6, or 7 and the preceding discussion of how to make them. It is particularly suited to forming an envelope having heat-sealed seams and a sealing flap such as the envelope with three heat-sealed seams forming an internal pouch and closure the sealing flap depicted in FIGS. 11A-11C. These packages are often called mailers and are used to ship products from online retailers to customers.

### Rotogravure Printing of the Foamable Composition—Hollow Bubbles

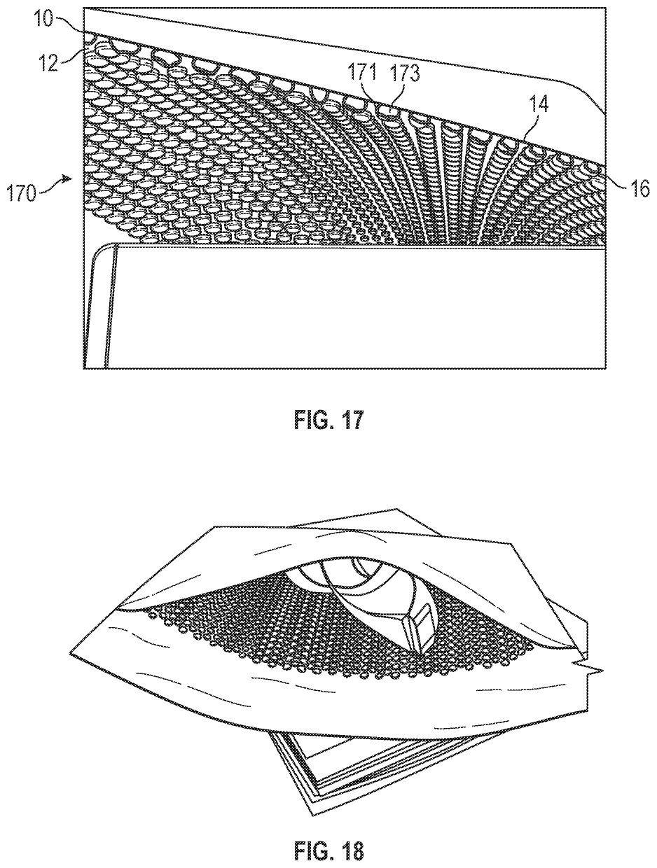

The following Examples illustrate rotogravure printing of the foamable composition to form a plurality of foam bubbles 170 having a foamed exterior shell 171 and a hollow interior 173 filled with air as best seen in FIG. 17. On the top edge of the substrate 10 in FIG. 17 the foam bubbles are cut open to expose the hollow interior center 173 and the foamed exterior shell 171 surrounding the hollow center. Tables 15 and 16 list the tested rotogravure roll patterns and additional materials used in the foamable composition. Tables 17-22 show the foamable composition wet weights and dry weights for the various Examples.

TABLE 15
Rotogravure Roll Patterns

| | Cell Depth | Cell Width | Cell Spacing d1 |
|---|---|---|---|
| Gravure Pattern | (mm) | (mm) | (mm) |
| 4 | 1.5 | 4 | 12 |
| 5 | 1.75 | 4 | 12 |
| 6 | 2 | 4 | 12 |

TABLE 16
Additional Materials

| Material | Description | Supplier |
|---|---|---|
| Dur-O-Set E-130 | A polyvinyl alcohol stabilized | Celanese, Florence, |
| | vinyl acetate ethylene | KY, USA |
| | (VAE) copolymer emulsion | |
| Dur-O-Set C-325 | A high-viscosity, polyvinyl | Celanese, Florence, |
| | acetate homopolymer | KY, USA |
| | emulsion | |
| Acrysol RM3000 | Rheology modifier | Dow Chemical, |
| | | Freeport, TX, USA |

TABLE 17
Additional Formulations Wet Weight

| | Dur-O- | G polymer | Expancel | Acrosyl | Penn Color |
|---|---|---|---|---|---|
| | Set 130, | 25% | 043 DU | RM3000, | 32n711, |
| Formu- | 55% | solids | 80 | 20% solid, | 58.5-64.5% |
| lation | solid | (g) | (g) | (g) | solid (g) |
| 11G | 19.46 | 7.93 | 1.18 | 0.98 | 0.24 |
| 15G | 15.87 | 15.68 | 1.18 | 0.98 | 0.24 |
| 16G (F133) | 11.5 | 25.3 | 0.8 | 0 | 0.12 |

TABLE 18
Additional Formulations Wet Weight

| | Dur-O- | G polymer | | Acrosyl | Penn Color |
|---|---|---|---|---|---|
| | Set 230, | 25% | Expancel | RM3000, | 32n711, |
| Formu- | 54% | solids | 043 DU 80 | 20% solid, | 58.5-64.5% |
| lation | solid | (g) | (g) | (g) | solid (g) |
| 12G | 15.87 | 15.68 | 1.18 | 0.98 | 0.24 |
| 13G | 22.67 | 1.00 | 1.18 | 0.98 | 0.24 |

TABLE 19
Additional Formulations Wet Weight

| | Dur-O- | G polymer | Expancel | Acrosyl | Penn Color |
|---|---|---|---|---|---|
| | Set 325, | 25% | 043 DU | RM3000, | 32n711, |
| | 55% | solids | 80 | 20% solid, | 58.5-64.5% |
| Formulation | solid (g) | (g) | (g) | (g) | solid (g) |
| 14G | 22.67 | 1.00 | 1.18 | 0.98 | 0.24 |

TABLE 20
Additional Formulations Dry Weight

| | Dur-O- | G | Expancel | Acrosyl | |
|---|---|---|---|---|---|
| | Set 130, | polymer | 043 DU 80 | RM3000, | Penn Color |
| Formulation | (g) | (g) | (g) | (g) | 32n711, (g) |
| 11G | 10.70 | 1.98 | 1.18 | 0.20 | 0.15 |
| 15G | 8.73 | 3.92 | 1.18 | 0.20 | 0.15 |

TABLE 21
Additional Formulations Dry Weight

| | | G polymer | Expancel | Acrosyl | Penn Color |
|---|---|---|---|---|---|
| Formu- | Dur-O- | 25% solids | 043 DU 80 | RM3000, | 32n711, |
| lation | Set 230 | (g) | (g) | (g) | (g) |
| 12G | 8.57 | 3.92 | 1.18 | 0.20 | 0.15 |
| 13G | 12.24 | 0.25 | 1.18 | 0.20 | 0.15 |

TABLE 22
Additional Formulations Dry Weight

| | Dur-O- | G | Expancel | Acrosyl | Penn Color |
|---|---|---|---|---|---|
| Formu- | Set 325, | polymer | 043 DU 80 | RM3000, | 32n711, |
| lation | (g) | (g) | (g) | (g) | (g) |
| 14G | 12.47 | 0.25 | 1.18 | 0.20 | 0.15 |

Tables 23-25 provide the results for the various Examples 8G-15G that were made. The basis weight, scam strength, coefficient of friction and bubble volume and outer shell thickness, and percent hollow core volume were determined for the samples. Each of the Examples produced a hollow bubble foam structure having an exterior shell of a foam material and a hollow interior filled with air as seen in FIG. 17.

TABLE 23
Resulting Foam Basis Weights

| | | | Total | | | Calculated | |
|---|---|---|---|---|---|---|---|
| | | | Coating | | Outer | Hollow | |
| | | | Basis | Bubble | Shell | Core | Hollow |
| | | Gravure | Wt | Volume | Thickness | Volume | Core % |
| Sample | Formulation | Pattern | (gsm) | (mm³) | (mm) | (mm³) | Volume |
| 8G | 11G | 4 | 43.7 | — | — | — | — |
| 9G | 11G | 5 | 52.9 | — | — | — | — |
| 10G | 11G | 6 | 52.5 | — | — | — | — |
| 11G | 11G | 4 | 39.7 | 15.0 | 0.148 | 13.0 | 86.9% |
| 12G | 12G | 5 | 44 | 16.1 | 0.185 | 13.1 | 81.1% |
| 13G | 13G | 4 | 40 | 12.1 | 0.170 | 10.1 | 83.6% |
| 14G | 14G | 4 | 27 | 18.4 | 0.180 | 15.8 | 85.7% |
| 15G | 15G | 5 | 32.5 | 15.4 | 0.168 | 13.1 | 85.4% |

TABLE 24
Resulting Seam Strength Coating With Foam Bubble Array

| | | Peak Force | Seam Width | Seam Strength |
|---|---|---|---|---|
| Sample | Formulation | (lbf) | (in) | (lbf/in) |
| 8G | 11G | 1.84 | 1.0 | 1.84 |
| 9G | 11G | 1.96 | 1.0 | 1.96 |
| 10G | 11G | 2.03 | 1.0 | 2.03 |
| 11G | 11G | | | |
| 12G | 12G | 1.67 | 1.0 | 1.67 |
| 13G | 13G | 0.69 | 1.00 | 0.69 |
| 14G | 14G | Did not test | Did not test | Did not test |
| 15G | 15G | 1.82 | 1.0 | 1.82 |

Samples in Table 24 were sealed at 360° F. actual temp (475 setpoint) for 0.8 seconds and 90 psi.

For the various Examples where the seam strength was 1.0 lbf/in or more adequate strength is developed to form a mailer from the coated substrate by heat sealing the edges. In general, higher seam strength is better and values above 1.5 lbf/in are preferred particularly when shipping heavier items in the mailer.

TABLE 25
Coefficient of Friction of Foam Bubbles

| Sample | Formulation | Steel Surface Finish | Static COF | Kinetic COF |
|---|---|---|---|---|
| 11G | 11G | mirror | 1.57 | 1.93 |
| 12G | 12G | mirror | 3.97 | 3.58 |
| 13G | 13G | mirror | 5.26 | 4.43 |
| 14G | 14G | mirror | 0.475 | 0.61 |
| 15G | 15G | mirror | 1.32 | 1.58 |
| 11G | 11G | matte | 0.97 | 1.04 |
| 12G | 12G | matte | 2.63 | 1.97 |
| 13G | 13G | matte | 4.05 | 2.98 |
| 14G | 14G | matte | 0.45 | 0.48 |
| 15G | 15G | matte | 0.79 | 0.76 |

Coefficient of Friction Test: The static and dynamic coefficient of friction of the discrete foamed bubbles coated on paper were determined using the procedures outlined in ASTM D1894-14 “Standard Test Method for Static and Kinetic Coefficients of Friction of Plastic Film and Sheeting”. The test setup followed setup C (moving sled-fixed plane) as described in ASTM 1894-14 using an Instron coefficient of friction test apparatus part #2810-005 (available from Instron, Norwood MA, USA) and were tested on an Instron Universal Testing Load Frame 5564 (available from Instron, Norwood MA, USA) using a 100N load cell. Specimens were tested against steel planes with either a mirror or matte finish. The steel planes were wiped with 70/30 Isopropyl alcohol/water prior to testing. Samples were conditioned overnight in a controlled temperature and humidity room at 22.8±1.1° C. (73.1±2° F.) and 50±2% relative humidity prior to testing. Test specimens were cut to size and adhered to the movable sled as outlined in the ASTM. The sled weight was 200 g+/−5 g with the attached specimen. A cross-head speed of 6″/min was used to test the specimen. Samples were tested in triplicate. The kinetic and static coefficients of friction were recorded and the average value is reported.

For foamed substrates that are formed into a mailer, a lower coefficient of friction is desirable for inserting items into the mailer and running the foamed substrate through the converting lines. In preferred embodiments, the kinetic COF can be less 2.0, or less than 1.5, or less than 1.0 and above 0.0.

The rotogravure coating process deposits the foamable composition onto the substrate in a an array of liquid dots. In other embodiments, a substantially continuous coating can also be applied to the substrate first or at the same time with the array of liquid dots. In one embodiment, a 55 lb (85 gsm) kraft paper substrate was used. The diameter and height of the dots can change as a function of the coating process parameters and the specific rotogravure pattern utilized, including the individual cell volume within the pattern. In one embodiment, the rotogravure cells forming the array of liquid dots where one-half of a 4 mm diameter sphere. The deposited liquid dot is dried in an oven, and foams during the drying process creating foam bubbles comprising an outer shell of a foam material and a hollow center or hollow core filled with air. It is believed that while drying the foamable composition, the outer surface skins over in the oven and the remaining water in the composition at least partially vaporizes into the center of the dot structure and exits through the substrate creating the final hollow core structure seen in FIG. 17. In particular, it was found that slowing down the web speed through the oven after the rotogravure printing process on the substrate was necessary to the formation of the skin layer and maximum hollow core volume within the foam bubble.

The hollow foam bubble structure has the advantage of creating a larger overall structure for a given amount of the foamable composition deposited than can be obtained with non-hollow core foam structures. Since they have an air-filled center, the final dried foam material is concentrated and utilized only in the outer shell of the structure. The resulting overall substrate coated with the foam is quite like a recyclable version of plastic (polyethylene) bubble wrap. It has a pleasing tactical sensation and good cushioning properties resulting from the hollow air-filled core of the foam bubbles just like plastic bubble wrap.

The resulting foam bubbles have a structure comprising an outer foam shell with a thickness ranging from 25-500 microns, or from 50-400 microns, or from 75 to 250 microns. In the various Examples 8G-15G, the outer foam shell thickness was determined to be between 50 to 250 microns. The resulting foam bubbles can have a structure with a hollow core or hollow center having a volume ranging from 2 to 5000 mm³, or from 3 to 1000 mm³, or from 5-500 mm³, or from 6 to 150 mm³. In the various Examples 8G-15G, the hollow core volume was calculated to be 10-15 mm³. The hollow core or hollow center volume as a percentage of the overall foam bubble volume can range from 5 to 95% of the total foam bubble volume, or from 5 to 75%, or from 10 to 50%, or from 15 to 45%. In the various Examples 8G-15G, the hollow core percent volume was calculated to between 81% to 87%.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1-104. (canceled)

105. A foam padded material comprising:
a sheet material having a first and a second major surface, wherein the sheet material comprises recyclable material; and
a foamed composition disposed on the first major surface of the sheet material, the foamed composition comprising:
a polymeric component comprising a hydroxy-ethylene-butylene copolymer comprising divalent hydroxyethylene monomer units and divalent dihydroxybutylene monomer units;
wherein the foamed composition is in the form of an at least partially water-soluble foam.

106. The foam padded material of claim 105, wherein the foamed composition is disposed in a discontinuous pattern comprising an array of discrete elements.

107. The foam padded material of claim 106, wherein the elements comprise one or more geometric shapes comprising squares, rectangles, triangles, spirals, lines, and circles.

108. The foam padded material of claim 105, wherein the recyclable material comprises a repulpable material, wherein the repulpable material comprises repulpable paper.

109. The foam padded material of claim 108, wherein the repulpable paper is selected from the group consisting of fibreboard, chipboard, corrugated boards corrugated medium, solid bleached board, solid bleached sulphite board, solid unbleached board, white lined chipboard, kraft paper, kraft board, coated paper, binder board, and mixtures thereof.

110. The foam padded material of claim 105, wherein the foamed composition covers at least 10% and up to 90% of the surface area of the sheet material.

111. The foam padded material of claim 105, wherein the hydroxy-ethylene-butylene copolymer comprises divalent hydroxyethylene monomer units and 3,4-dihydroxybutan-1,2-diyl monomer units.

112. The foam padded material of claim 105, wherein the hydroxy-ethylene-butylene copolymer has at least one of the following properties:
a melt flow index of 0.1 gram per 10 minutes to 60 grams per 10 minute (measured at 210° C. with a load of 2.16 kilograms); or
a melt temperature of 90° C. to 220° C. (measured by Differential Scanning Calorimetry).

113. The foam padded material of claim 105, wherein the polymeric component of the foamed composition comprises at least one weight percent and up to 100 weight percent of the hydroxy-ethylene-butylene copolymer, based on the total weight of the polymeric component of the foamed composition.

114. The foam padded material of claim 105, wherein the polymeric component further comprises a secondary polymer.

115. The foam padded material of claim 114, wherein the secondary polymer is selected from the group consisting of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (meth)acrylic, styrene (meth)acrylic, (meth)acrylic, styrene butyl rubber, natural rubber, styrenic block copolymer, polyurethane, and mixtures thereof.

116. The foam padded material of claim 115, wherein the polymeric component further comprises a polyvinyl alcohol stabilized vinyl acetate ethylene.

117. The foam padded material of claim 105, further comprising expanded microspheres combined with the polymeric component.

118. A method of making the foam padded material of claim 105, the method comprising:
providing a sheet material having a first and a second major surface, wherein the sheet material comprises recyclable material;
providing a foamable water-containing composition comprising a polymeric component comprising a hydroxy-ethylene-butylene copolymer;
applying the foamable composition to at least a portion of the first major surface of the sheet material to form a coated substrate; and
exposing the coated substrate to conditions effective to form a foam from the foamable composition.

119. The method of claim 118, wherein applying comprises screen printing or random element printing the foamable composition.

120. A packaging article comprising the foam padded material of claim 105.

121. The packaging article of claim 120 in the form of an envelope.

122. The packaging article of claim 120 comprising:
a first wall having a first interior surface and a first exterior surface opposite the first interior surface;
a second wall having a second interior surface and a second exterior surface opposite the second interior surface, the first and second interior surfaces defining an interior of the packaging article and the first and second exterior surfaces defining an exterior of the packaging article;
a foamed composition disposed on at least a portion of each of the first and second interior surfaces; and
a sealing joint at one or more edges of the first and second walls, the sealing joint comprising the foamed composition, which attaches the first wall to the second wall;
wherein the first and second walls comprise the sheet material comprising recyclable material; and
wherein the foamed composition comprises:
a polymeric component comprising a hydroxy-ethylene-butylene copolymer comprising divalent hydroxyethylene monomer units and divalent dihydroxybutylene monomer units; and
wherein the foamed composition is in the form of an at least partially water-soluble foam.

123. The packaging article of claim 122, wherein the first wall further comprises a flap that is adapted to be folded between an open configuration and a closed configuration, and that extends beyond the opening of the packaging article in the open configuration and covers the opening in the packaging article in the closed configuration.

124. The packaging article of claim 123, wherein the flap has at least one adhesive portion disposed thereon.
